(19) United States
(12) Patent Application Publication
(10) Pub. No.: US 2013/0003181 A1
(43) Pub. Date: Jan. 3, 2013

(54) TRANSPARENT CONDUCTIVE ELEMENT, INPUT DEVICE, AND DISPLAY APPARATUS

(75) Inventors: Kazuya Hayashibe, Miyagi (JP); Shunichi Kajiya, Miyagi (JP); Yutaka Muramoto, Miyagi (JP)

(73) Assignee: SONY CORPORATION, Tokyo (JP)

(21) Appl. No.: 13/634,172

(22) PCT Filed: Jan. 31, 2011
(86) PCT No.: PCT/JP2011/052455

§ 371 Date: Sep. 11, 2012

(30) Foreign Application Priority Data
Jan. 19, 2011 (JP) 2011-009322

(51) Int. Cl. G02B 1/11

(52) U.S. Cl. 359/585

(57) ABSTRACT

A transparent conductive element includes: an optical layer on which a wave surface with an average wavelength equal to or less than a wavelength of visible light is provided; and a transparent conductive layer that is formed on the wave surface so as to follow the corresponding wave surface. Assuming that the average wavelength of the wave surface is λm and the average width of oscillation of the wave surface is Am, a ratio of (Am/λm) is 0.2 or more and 1.0 or less. The average wavelength λm of the wave surface is 140 nm or more and 300 nm or less. The film thickness of the transparent conductive layer at a position, at which the height of the wave surface is maximized, is 100 nm or less. The area of a planar portion of the wave surface is 50% or less.

### TECHNICAL FIELD

The present invention relates to a transparent conductive element, an input device, and a display apparatus. Specifically, the present invention relates to a transparent conductive element which has an antireflection function.

### BACKGROUND ART

Display apparatuses such as an electronic paper and input devices such as a touch panel employ a transparent conductive element in which a transparent conductive layer is formed on a flat surface of a base substance. As a material of the transparent conductive layer used in the transparent conductive element, a material with a high refractive index (for example, ITO (Indium Tin Oxide)), in which the refractive index is about 2.0, is used. For this reason, the reflectance increases in accordance with the thickness of the transparent conductive layer, and thus this may cause trouble in qualities of the display apparatuses and the input devices.

Conventionally, in order to improve the transmission characteristics of the transparent conductive element, a technique of forming an optical multilayer film is used. For example, Japanese Unexamined Patent Application Publication No. 2003-136625 proposes a transparent conductive element for a touch panel in which the optical multilayer film is provided between the substrate and the transparent conductive layer. The optical multilayer film is formed by sequentially laminating a plurality of dielectric films each of which has different refractive indices. However, in this technique, wavelength dependency arises in an optical adjustment function. Here, the optical adjustment function means an optical adjustment function of the transmission characteristic and/or the reflection characteristic.

### DISCLOSURE OF INVENTION

### Technical Problem

Accordingly, it is an object of the present invention to provide a transparent conductive element, an input device, and a display apparatus having an optical adjustment function of which the wavelength dependency is small and which is excellent in visibility.

### Technical Solution

The present invention provides a transparent conductive element including:

an optical layer on which a wave surface with an average wavelength equal to or less than a wavelength of visible light is provided; and

a transparent conductive layer that is formed on the wave surface so as to follow the corresponding wave surface,

in which assuming that the average wavelength of the wave surface is λm and the average width of oscillation of the wave surface is Am, a ratio of (Am/λm) is 0.2 or more and 1.0 or less,

in which the average wavelength λm of the wave surface is 140 nm or more and 300 nm or less,

in which the film thickness of the transparent conductive layer at a position, at which the height of the wave surface is maximized, is 100 nm or less,

in which the area of a planar portion of the wave surface is 50% or less, and

in which a reflected hue on the wave surface side in an L*a*b* color system is |a*|≦10 and |b*|≦10.

The transparent conductive element according to the present invention is very appropriate to application to an input device, a display apparatus, and the like.

In the present invention, the shapes of an ellipse, a circle (true circle), a sphere, an ellipsoidal body, and the like includes not only shapes of a perfect ellipse, circle, sphere, and ellipsoidal body which are mathematically defined but also shapes of an ellipse, circle, sphere, ellipsoidal body, and the like which are slightly distorted.

In the present invention, it is preferable that the wave surface of the optical layer should be formed by arranging the plurality of structures on the base substance surface. It is preferable that the structures should have a convex shape or a concave shape and should be arranged in a prescribed lattice shape. It is preferable to use a tetragonal lattice shape, a quasi-tetragonal lattice shape, a hexagonal lattice shape, or a quasi-hexagonal lattice shape as the lattice shape.

In the present invention, it is preferable that the array pitch P1 of the structures in the same track should be longer than the array pitch P2 of the structures in the space of two tracks adjacent to each other. In such a manner, it is possible to improve the filling rate of the structures which have an elliptical cone shape or an elliptical frustum shape. Therefore, it is possible to improve the optical adjustment function.

In the present invention, the respective structures may be formed in a hexagonal lattice pattern or a quasi-hexagonal lattice pattern on the base substance surface. In this case, it is preferable that, assuming that the array pitch of the structures in the same track is P1 and the array pitch of the structures in the space of two tracks adjacent to each other is P2, a ratio of P1/P2 should satisfy the relationship of 1.00≦P1/P2≦1.1 or 1.00<P1/P2≦1.1. By setting such a numerical range, it is possible to improve the filling rate of the structures which have an elliptical cone shape or an elliptical frustum shape. Therefore, it is possible to improve the optical adjustment function.

In the present invention, the respective structures may be formed in a hexagonal lattice pattern or a quasi-hexagonal lattice pattern on the base substance surface. In this case, it is preferable that the major axis direction of each structure should be the track extension direction in which the track extends, and it is preferable that each structure should have an elliptical cone or an elliptical frustum shape in which the inclination of the center portion thereof should be steeper than the inclinations of the tip end portion and the bottom portion thereof. With such a shape, it is possible to improve the optical adjustment function of the reflection and transmission characteristics.

In the present invention, the respective structures may be formed in a hexagonal lattice pattern or a quasi-hexagonal lattice pattern on the base substance surface. In this case, it is preferable that the height or depth of each structure in the track extension direction should be smaller than the height or depth of each structure in the column direction of the track. When the relationship is not satisfied, it is necessary to elongate the array pitch in the track extension direction. Hence, the filling rate of the structures in the track extension direction decreases. As described above, when the filling rate decreases, the reflection characteristic deteriorates.

In the present invention, the respective structures may be formed in a hexagonal lattice pattern or a tetragonal lattice pattern or a quasi-tetragonal lattice pattern on the base substance surface. In this case, it is preferable that the array pitch P1 of the structures in the same track should be longer than the array pitch P2 of the structures in the space of two tracks adjacent to each other. In such a manner, it is possible to improve the filling rate of the structures which have an elliptical cone shape or an elliptical frustum shape. Therefore, it is possible to improve the optical adjustment function.

When the respective structures are formed in a hexagonal lattice pattern or a tetragonal lattice pattern or a quasi-tetragonal lattice pattern on the base substance surface, it is preferable that, assuming that the array pitch of the structures in the same track is P1 and the array pitch of the structures in the space of two tracks adjacent to each other is P2, a ratio of P1/P2 should satisfy the relationship of 1.4<P1/P2≦1.5. By setting such a numerical range, it is possible to improve the filling rate of the structures which have an elliptical cone shape or an elliptical frustum shape. Therefore, it is possible to improve the optical adjustment function.

When the respective structures are formed in a hexagonal lattice pattern or a tetragonal lattice pattern or a quasi-tetragonal lattice pattern on the base substance surface, it is preferable that the major axis direction of each structure should be the track extension direction, and it is preferable that each structure should have an elliptical cone or an elliptical frustum shape in which the inclination of the center portion thereof should be steeper than the inclinations of the tip end portion and the bottom portion thereof. With such a shape, light with the reflection and transmission characteristics is able to improve the adjustment function.

When the respective structures are formed in a hexagonal lattice pattern or a tetragonal lattice pattern or a quasi-tetragonal lattice pattern on the base substance surface, it is preferable that the height or depth of each structure in the direction of 45 degrees or the direction of about 45 degrees with respect to the track should be smaller than the height or depth of each structure in the column direction of the track. When the relationship is not satisfied, it is necessary to elongate the array pitch in the direction of 45 degrees or the direction of about 45 degrees with respect to the track. Hence, the filling rate of the structures in the direction of 45 degrees or the direction of about 45 degrees with respect to the track. As described above, when the filling rate decreases, the reflection characteristic deteriorates.

In the present invention, it is preferable that multiple structures, which are arranged on the base substance surface at a fine pitch, should constitute a plurality of columns of tracks, and should be formed in the hexagonal lattice pattern, the quasi-hexagonal lattice pattern, the tetragonal lattice pattern, or the quasi-tetragonal lattice pattern among the three columns of tracks adjacent to one another. Thereby, it is possible to increase the filling density of the structures on the surface, and thus it is possible to obtain an optical element in which the optical adjustment function of the reflection and transmission characteristics of visible light is improved.

In the present invention, it is preferable to manufacture the optical element by using a method in which a process of manufacturing a master mold of an optical disk and an etching process are combined. It is possible to efficiently manufacture the master mold for manufacturing the optical element for a short period of time, and it is possible to cope with an increase in size of the base substance. Thereby, it is possible to improve productivity of the optical element.

In the present invention, the transparent conductive layer with the prescribed pattern is formed on the optical layer on which the wave surface with the average wavelength equal to or less than the wavelength of visible light is provided so as to follow the corresponding wave surface. Therefore, it is possible to obtain an optical adjustment function of which the wavelength dependency is small and which is excellent in visibility.

### Advantageous Effects

As described above, according to the present invention, it is possible to implement an optical adjustment function of which the wavelength dependency is small and which is excellent in visibility.

### BRIEF DESCRIPTION OF DRAWINGS

FIG. 1A is a sectional view illustrating an example of a configuration of a transparent conductive element according to a first embodiment of the present invention.

FIG. 1B is an enlarged sectional view illustrating a first region R1 shown in FIG. 1A in an enlarged manner.

FIG. 1C is an enlarged sectional view illustrating a second region R2 shown in FIG. 1A in an enlarged manner.

FIG. 2A is a sectional view illustrating another example of the configuration of the transparent conductive element according to the first embodiment of the present invention.

FIG. 2B is an enlarged sectional view illustrating a first region R1 shown in FIG. 2A in an enlarged manner.

FIG. 2C is an enlarged sectional view illustrating a second region R2 shown in FIG. 2A in an enlarged manner.

FIG. 3A is a top plan view illustrating an example of an optical layer surface on which a plurality of structures is formed.

FIG. 3B is a top plan view illustrating a part of the optical layer surface shown in FIG. 3A in an enlarged manner.

FIG. 3C is a perspective view illustrating a part of the optical layer surface shown in FIG. 3A in an enlarged manner.

FIG. 4 is a schematic view illustrating a method of setting a structure bottom face when the boundaries of the structures are not clear.

FIG. 5A is an enlarged sectional view illustrating an example of a surface shape of the transparent conductive layer.

FIG. 5B is an enlarged sectional view illustrating the film thickness of the transparent conductive layer which is formed on the structure with a convex shape.

FIG. 6A is a perspective view illustrating an example of a configuration of a roll master mold.

FIG. 6B is a top plan view illustrating a part of the roll master mold shown in FIG. 6A in an enlarged manner.

FIG. 6C is a sectional view of a track T of FIG. 6B.

FIG. 7 is a schematic view illustrating an example of a configuration of an apparatus for exposing the roll mater disk.

FIGS. 8A to 8D are process diagrams illustrating an example of a method of manufacturing the transparent conductive element according to the first embodiment of the present invention.

FIGS. 9A to 9D are process diagrams illustrating an example of a method of manufacturing the transparent conductive element according to the first embodiment of the present invention.

FIG. 10A is a top plan view illustrating an example of an optical layer surface of a transparent conductive element according to a second embodiment of the present invention.

FIG. 10B is a top plan view illustrating a part of the optical layer surface shown in FIG. 10A in an enlarged manner.

FIG. 11A is a sectional view illustrating an example of a configuration of a transparent conductive element according to a third embodiment of the present invention.

FIG. 11B is a top plan view illustrating an example of an optical layer surface of the transparent conductive element according to the third embodiment of the present invention.

FIG. 11C is a top plan view illustrating a part of the optical layer surface shown in FIG. 11B in an enlarged manner.

FIG. 12A is a sectional view illustrating an example of a configuration of a transparent conductive element according to a fourth embodiment of the present invention.

FIG. 12B is an enlarged sectional view illustrating a part of the optical layer surface shown in FIG. 12A in an enlarged manner.

FIG. 12C is a sectional view illustrating another example of the configuration of the transparent conductive element according to the fourth embodiment of the present invention.

FIG. 12D is an enlarged sectional view illustrating a part of the optical layer surface shown in FIG. 12C in an enlarged manner.

FIG. 13A is a sectional view illustrating an example of a configuration of an information input device according to a fifth embodiment of the present invention.

FIG. 13B is an enlarged sectional view illustrating a region A1 and a region A2 shown in FIG. 13A in an enlarged manner.

FIG. 14A is an enlarged sectional view illustrating the region A₁ shown in FIG. 13A in a further enlarged manner.

FIG. 14B is an enlarged sectional view illustrating the region A₂ shown in FIG. 13A in a further enlarged manner.

FIG. 15A is an exploded perspective view illustrating the example of the configuration of the information input device according to the fifth embodiment of the present invention.

FIG. 15B is an exploded perspective view illustrating a configuration of a first transparent conductive element which is provided in the information input device according to the fifth embodiment of the present invention.

FIG. 16A is a sectional view illustrating an example of a configuration of an information input device according to a sixth embodiment of the present invention.

FIG. 16B is an enlarged sectional view illustrating a part of the information input device shown in FIG. 16A in an enlarged manner.

FIG. 17A is a sectional view illustrating an example of a configuration of an information input device according to a seventh embodiment of the present invention.

FIG. 17B is a sectional view illustrating a region facing the wave surface, on which the transparent conductive layer is formed, in an enlarged manner.

FIG. 17C is a sectional view illustrating a region facing the wave surface on which the transparent conductive layer is not formed and which is exposed, in an enlarged manner.

FIG. 18A is an exploded perspective view illustrating an example of the configuration of the information input device according to the seventh embodiment of the present invention.

FIG. 18B is an exploded perspective view illustrating a configuration of a transparent conductive element which is provided in the information input device according to the seventh embodiment of the present invention.

FIG. 19A is a sectional view illustrating an example of a configuration of an information input device according to an eighth embodiment of the present invention.

FIG. 19B is an enlarged sectional view illustrating a part of the information input device shown in FIG. 19A in an enlarged manner.

FIG. 20 is a sectional view illustrating an example of a configuration of a liquid crystal display apparatus according to a ninth embodiment of the present invention.

FIG. 21A is a perspective view illustrating an example of a configuration of an information display apparatus according to a tenth embodiment of the present invention.

FIG. 21B is a sectional view illustrating a region facing the wave surface, on which the transparent conductive layer is formed, in an enlarged manner.

FIG. 21C is a sectional view illustrating a region facing the wave surface on which the transparent conductive layer is not formed and which is exposed, in an enlarged manner.

FIG. 22A is a sectional view illustrating an example of a configuration of an information display apparatus according to an eleventh embodiment of the present invention.

FIG. 22B is a sectional view illustrating a region facing the wave surface, on which the transparent conductive layer is formed, in an enlarged manner.

FIG. 22C is a sectional view illustrating a region facing the wave surface on which the transparent conductive layer is not formed and which is exposed, in an enlarged manner.

FIG. 23A is a top plan view illustrating the plurality of structures which are arranged on the base substance surface of samples 1-1 to 1-3.

FIG. 23B is a graph illustrating reflection spectra of the transparent conductive elements of samples 1-1 to 1-3.

FIG. 24 is a graph illustrating measurement results of transmission spectra of the transparent conductive elements of samples 2-1 to 2-3.

FIG. 25A is a graph illustrating reflection spectra of the transparent conductive elements of samples 3-1 to 3-3.

FIG. 25B is a graph illustrating transmission spectra of the transparent conductive elements of samples 3-1 to 3-3.

FIG. 26 is a graph illustrating reflection spectra of the transparent conductive elements of samples 4-1 to 4-4.

FIG. 27 is a graph illustrating a reflectance difference ΔR between the transparent conductive elements of samples 6-1 and 6-2 and samples 6-3 and 6-4.

FIG. 28A is a graph illustrating a reflectance spectrum of the transparent conductive element of sample 7-1.

FIG. 28B is a graph illustrating a reflectance spectrum of the transparent conductive element of sample 7-2.

FIG. 28C is a graph illustrating a reflectance spectrum of the transparent conductive element of sample 7-3.

FIG. 29A is a sectional view illustrating thicknesses D1, D2, and D3 of the transparent conductive layer of sample 7-2.

FIG. 29B is a sectional view illustrating thicknesses D1, D2, and D3 of the transparent conductive layer of sample 7-3.

FIG. 30 is a graph illustrating measurement results of surface resistance values of transparent conductive sheets of samples 9-1 to 10-5.

### BEST MODES FOR CARRYING OUT THE INVENTION

Description will be given of embodiments of the present invention in order of the following items with reference to the drawings. In addition, in the entire diagrams of the following embodiments, in the case where common or corresponding elements exist, those elements will be represented by the same reference numerals and signs.

1. First Embodiment (an example of a transparent conductive element in which structures are arranged in a hexagonal lattice shape)

2. Second Embodiment (an example of a transparent conductive element in which structures are arranged in a tetragonal lattice shape)

3. Third Embodiment (an example of a transparent conductive element in which structures are randomly arranged)

4. Fourth Embodiment (an example of the transparent conductive element in which the transparent conductive layer is continuously formed on the entire wave surface)

5. Fifth Embodiment (a first application example of the transparent conductive element applied to an information input device)

6. Sixth Embodiment (a second application example of the transparent conductive element applied to the information input device)

7. Seventh Embodiment (a third application example of the transparent conductive element applied to the information input device)

8. Eighth Embodiment (a fourth application example of the transparent conductive element applied to the information input device)

9. Ninth Embodiment (a first application example of the transparent conductive element applied to an information display apparatus)

10. Tenth Embodiment (a second application example of the transparent conductive element applied to the information display apparatus)

11. Eleventh Embodiment (a third application example of the transparent conductive element applied to the information display apparatus)

### 1. First Embodiment

The present inventors and the like made an intensive study to solve the above-mentioned problems. As a result, they contrived a transparent conductive element where a transparent conductive layer is formed on an optical layer, on which a wave surface with an average wavelength equal to or less than the wavelength of visible light is formed, so as to follow the corresponding wave surface.

However, according to the finding of the present inventors and the like, when the transparent conductive layer is formed in a prescribed pattern even in the transparent conductive element, the transparent conductive layer with the prescribed pattern is made to be visible due to a reflectance difference ΔR between a part in which the transparent conductive layer is formed and a part in which the transparent conductive layer is not formed. For this reason, the present inventors and the like made an intensive study to prevent the transparent conductive layer with the prescribed pattern from being visible. As a result of the keen examination, the inventors found that, by setting a ratio (A/λ) of the oscillation width A to the wave surface wavelength λ in the range of 0.2 or more and 1.0 or less, it is possible to suppress the reflectance difference ΔR.

### [Configuration of Transparent Conductive Element]

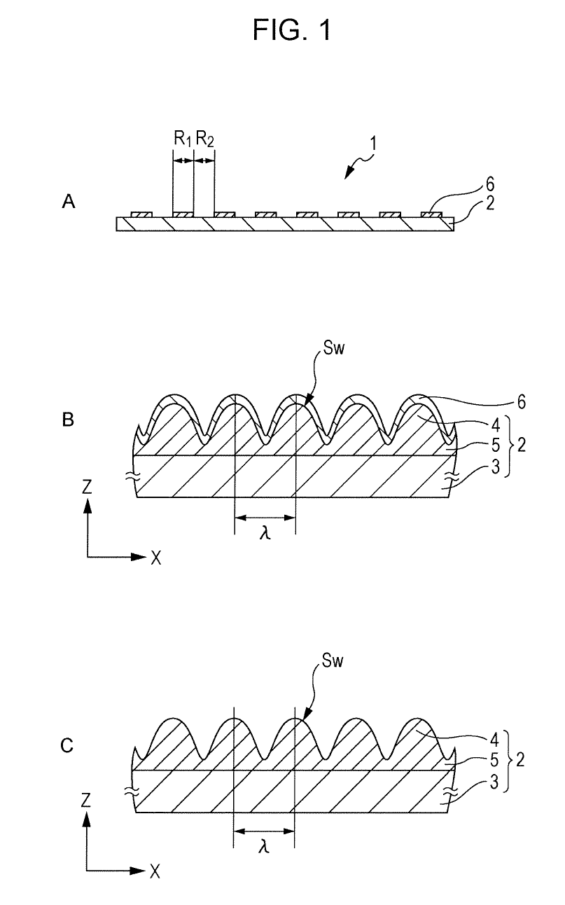

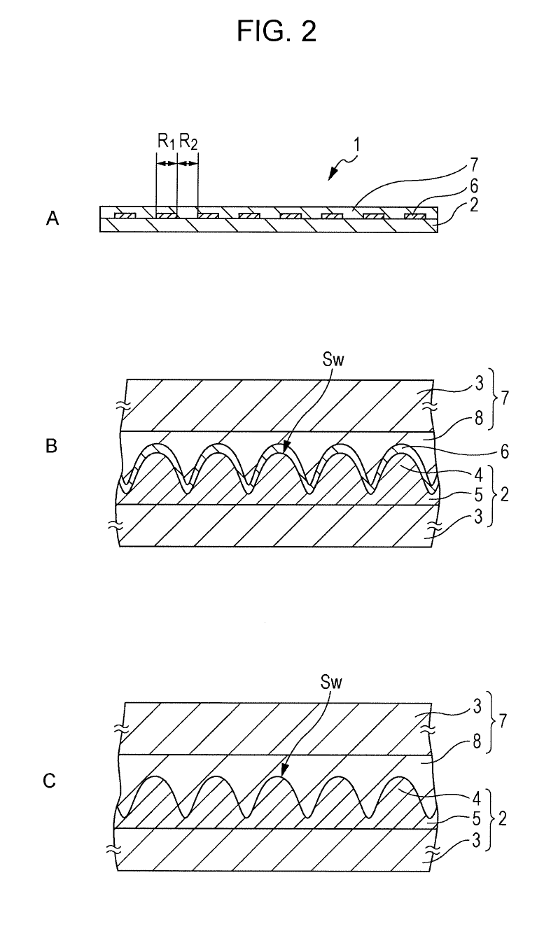

FIG. 1A is a sectional view illustrating an example of a configuration of a transparent conductive element according to a first embodiment of the present invention. FIG. 1B is an enlarged sectional view illustrating a first region R₁ shown in FIG. 1A in an enlarged manner. FIG. 1C is an enlarged sectional view illustrating a second region R₂ shown in FIG. 1A in an enlarged manner. The transparent conductive element 1 includes an optical layer (a first optical layer) 2 that has a wave surface Sw on one principal surface, and a transparent conductive layer 6 that is formed on the wave surface Sw so as to follow the wave surface Sw. The first region R₁, in which the transparent conductive layer 6 is formed, and the second region R₂, in which the transparent conductive layer 6 is not formed, are alternately arranged on the wave surface Sw of the optical layer 2, where the transparent conductive layer 6 has a prescribed pattern. Further, if necessary, as shown in FIGS. 2A to 2C, there are further provided an optical layer (a second optical layer) 7 that is formed on the transparent conductive layer 6, whereby the both principal surfaces of the transparent conductive layer 6 may be configured to be respectively covered by the optical layer 2 and the optical layer 7. It is preferable that the transparent conductive element 1 should have flexibility.

(Optical Layer)

The optical layer 2 includes, for example, a base substance 3, and a plurality of structures 4 which are formed on the surface of the base substance 3. By forming the plurality of structures 4 on the surface of the base substance 3, the wave surface Sw is formed. The structures 4 and the base substance 3 are, for example, individually or integrally formed. In the case where the structures 4 and the base substance 3 are individually formed, as necessary, a basal layer 5 is further provided between the structures 4 and the base substance 3. The basal layer 5 is a layer which is integrally formed on the bottom face side of the structures 4 together with the structures 4, and is formed by curing a resin composition through energy beams like the structures 4.

The optical layer 7 includes, for example, the base substance 3 and a paste layer 8 that is provided between the base substance 3 and the transparent conductive layer 6, and is assembled by attaching the base substance 3 onto the transparent conductive layer 6 through the paste layer 8. The optical layer 7 is not limited to this example, and may be a ceramic coat (an overcoat) of SiO₂ or the like.

The ratio (Am/λm) of the average width Am of oscillation of the wave surface Sw to the average wavelength λm of the wave surface Sw is in the range of preferably 0.2 or more and 1.0 or less, and more preferably 0.3 or more and 0.8 or less. If the ratio (Am/λm) is less than 0.2, the optical adjustment function using the wave surface Sw tends to deteriorate. In contrast, if the ratio (Am/λm) is greater than 1.0, the electric reliability tends to deteriorate.

It is preferable that the average wavelength λm of the wave surface Sw should be equal to or less than a wavelength band of light for the optical adjustment function. The wavelength band of the light for the optical adjustment function is, for example, the ultraviolet wavelength band, the wavelength band of visible light, or the infrared wavelength band. Here, the wavelength band is defined as a wavelength band of 10 nm to 360 nm as the ultraviolet wavelength band, a wavelength band of 360 nm to 830 nm as the wavelength band of visible light, and a wavelength band of 830 nm to 1 mm as the infrared wavelength band. Specifically, the average wavelength λm of the wave surface Sw is in the range of preferably 140 nm or more and 300 nm or less, and more preferably 150 nm or more and 270 nm or less. If the average width Am of oscillation of the wave surface Sw is less than 140 nm, the electric characteristics tend to deteriorate. In contrast, if the average width Am of oscillation of the wave surface Sw is greater than 300 nm, the visibility tends to deteriorate.

The average width Am of oscillation of the wave surface Sw is in the range of preferably 28 nm or more and 300 nm or less, more preferably 50 nm or more and 240 nm or less, and further more preferably 80 nm or more and 240 nm or less. If the average width Am of oscillation of the wave surface Sw is less than 28 nm, the optical adjustment function tends to deteriorate. In contrast, if the average width Am of oscillation of the wave surface Sw is greater than 300 nm, the electric characteristics tend to deteriorate.

Here, the average wavelength λm of the wave surface Sw, the average width Am of the oscillation, and the ratio (Am/λm) are obtained in the following manner. First, the transparent conductive element 1 is cut in a single direction so as to include a position at which the width of oscillation of the wave surface Sw is maximized, and then the section thereof is photographed by a transmission electron microscope (TEM). Subsequently, from the taken TEM picture, the wavelength λ of the wave surface Sw and the width A of the oscillation are obtained. The measurement is repeated at 10 locations which are randomly selected from the transparent conductive element 1, and the measurement values are simply averaged (arithmetically averaged), thereby obtaining the average wavelength λm of the wave surface Sw and the average width Am of the oscillation. Then, by using the average wavelength λm and the average width Am of the oscillation, the ratio (Am/λm) is calculated.

The average angle of the inclined surfaces in the wave surface Sw is in the range of preferably 60° or less, and more preferably 30° or more and 60° or less. If the average angle is less than 30°, the electric reliability based on the wave surface Sw tends to deteriorate. In contrast, if the average angle is greater than 60°, the electric reliability tends to deteriorate. Further, if the average angle is greater than 60°, the etching resistance of the transparent conductive layer 6 tends to deteriorate.

As shown in FIGS. 2A to 2C, when the optical layer 7 is further formed on the transparent conductive layer 6, the reflectance difference ΔR (=R2−R1) between the reflectance R1 of the first region R₁, in which the transparent conductive layer 6 is formed, and the reflectance R2 of the second region R₂, in which the transparent conductive layer 6 is not formed, is in the range of preferably 5% or less, more preferably 3% or less, and further more preferably 1% or less. By setting the reflectance difference ΔR to 5% or less, it is possible to prevent the transparent conductive layer 6 with a prescribed pattern from being visible.

A shown in FIGS. 1A to 1C, when the transparent conductive layer 6 is exposed, the transmitted hue in the L*a*b* color system on the principal surface on the optical layer 2 side among the both principal surfaces of the transparent conductive element 1 is preferably |a*|≦10 and |b*|≦10, more preferably |a*|≦5 and |b*|≦5, and further more preferably |a*|≦3 and |b*|≦3. By setting the transmitted hue to |a*|≦10 and |b*|≦10, it is possible to improve the visibility.

As shown in FIGS. 2A to 2C, when the optical layer 7 is further formed on the transparent conductive layer 6, the transmitted hue in the L*a*b* color system on the principal surface on the optical layer 2 side among the both principal surfaces of the transparent conductive element 1 is preferably |a*|≦5 and |b*|≦5, more preferably |a*|≦3 and |b*|≦3, and further more preferably |a*|≦2 and |b*|≦2. By setting the transmitted hue to |a*|≦5 and |b*|≦5, it is possible to improve the visibility.

As shown in FIGS. 1A to 1C, when transparent conductive layer 6 is exposed, the reflected hue in the L*a*b* color system on the principal surface on the transparent conductive layer 6 side among the both principal surfaces of the transparent conductive element 1 is preferably |a*|≦10 and |b*|≦10. By setting the reflected hue to |a*|≦10 and |b*|≦10, it is possible to improve the visibility.

As shown in FIGS. 2A to 2C, when the optical layer 7 is further formed on the transparent conductive layer 6, the reflected hue in the L*a*b* color system on the principal surface on the transparent conductive layer 6 side among the both principal surfaces of the transparent conductive element 1 is preferably |a*|≦10 and |b*|≦10, more preferably |a*|≦5 and |b*|≦5, and further more preferably |a*|≦3 and |b*|≦3. By setting the transmitted hue to |a*|≦10 and |b*|≦10, it is possible to improve the visibility.

(Base Substance)

The base substances 3 and 8 are, for example, transparent base substances which have transparency. Examples of the material of the base substances 3 and 8 include plastic materials with transparency and materials consist primarily of glass or the like, but the material is not particularly limited to the examples.

As the glass, for example, soda-lime glass, lead glass, hard glass, quartz glass, liquid crystal glass, or the like (refer to “chemistry handbook” basic edition, P.I-537, The Chemical Society of Japan) is used. From the viewpoint of optical characteristics such as transparency, a refractive index, and dispersion and various characteristics such as impact resistance, heat resistance, and durability, examples of the plastic material include: (meth)acrylic resin such as a copolymer between polymethyl methacrylate or methyl methacrylate and a vinyl monomer of alkyl(meth)acrylate or styrene; polycarbonate resin such as polycarbonate or diethylene glycol bisallyl carbonate (CR-39); thermosetting (meth)acrylic resin such as a copolymer or a homopolymer of (brominated) bisphenol-A-type di(meth)acrylate, a copolymer and a polymer of urethane modified monomers of (brominated) bisphenol A mono(meth)acrylate; polyester, particularly, polyethylene terephthalate, polyethylene naphthalate and unsaturated polyester, acrylonitrile-styrene copolymer, polyvinyl chloride, polyurethane, epoxy resin, polyarylate, polyether sulfone, polyether ketone, cycloolefin polymer (product name: Arton, Zeonor), cycloolefin copolymer, and the like. Further, it is also possible to use aramid resin in consideration of heat resistance.

When a plastic material is used as the base substances 3 and 8, a first coat layer may be provided through a surface treatment in order to further improve surface energy, coating property, sliding property, flatness, and the like of the plastic surface. Examples of the first coat layer include, for example, organo alkoxy metal compounds, polyester, acryl modified polyester, polyurethane, and the like. Further, in order to obtain the effect the same as the effect which is obtained by providing the first coat layer, corona discharge, an UV irradiation treatment may be performed on the surfaces of the base substances 3 and 8.

When the base substances 3 and 8 are plastic films, the base substances 3 and 8 can be obtained by, for example, a method of extending the above-mentioned resin or diluting the resin in a solvent and subsequently forming and drying the resin on the film. Further, it is preferable to appropriately select the thicknesses of the base substances 3 and 8 in accordance with the application of the conductive element 211, and the thickness is, for example, about 25 μm to 500 μm.

Examples of the shapes of the base substances 3 and 8 include a sheet shape, a plate shape, and a block shape, but the shapes are not particularly limited to the examples. Here, the sheet is defined to include a film.

(Structure)

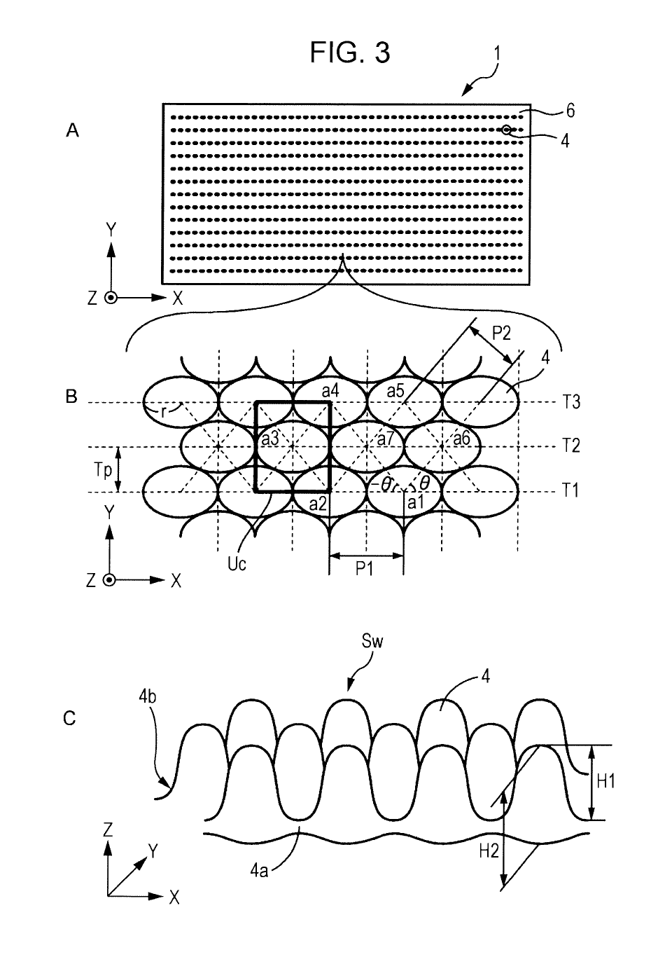

FIG. 3A is a top plan view illustrating an example of an optical layer surface on which a plurality of structures are formed. FIG. 3B is a top plan view illustrating a part of the optical layer surface shown in FIG. 3A in an enlarged manner. FIG. 3C is a perspective view illustrating a part of the optical layer surface shown in FIG. 3A in an enlarged manner. Hereinafter, assuming that two directions, which are orthogonal to each other in the plane of the principal surface of the transparent conductive element 1, are respectively the X-axis direction and the Y-axis direction, the direction perpendicular to the principal surface is referred to as the Z-axis direction. The structures 4 have, for example, convex shapes or concave shapes on the surface of the base substance 3, and are two-dimensionally arranged on the surface of the base substance 3. It is preferable that the structures 4 should be two dimensionally arranged on a periodic basis at a short average array pitch equal to or less than the wavelength band of light for reducing the reflection.

The plurality of structures 4 has an arrangement form that constitutes a plurality of columns of tracks T1, T2, T3, . . . (hereinafter, collectively referred to as “tracks T”) on the surface of the base substance 3. In the present invention, the track means a part in which the structures 4 are connected to be arrayed in a column. As the shape of the tracks T, it is possible to use a linear shape, an arc shape, and the like, and thus the tracks T having such a shape may be wobbled (staggered). As described above, by wobbling the tracks T, it is possible to suppress occurrence of seeming unevenness.

When the tracks T are wobbled, it is preferable that the wobbles of tracks T on the base substance 3 should be synchronous to one another. That is, it is preferable that the wobbles should be synchronized wobbles. In such a manner, by synchronizing the wobbles, it is possible to maintain a unit cell shape of a hexagonal lattice or a quasi-hexagonal lattice, and it is possible to keep the filling rate high. Examples of waveforms of the wobbled tracks T include a sine wave, a triangular wave, and the like. The waveform of the wobbled track T is not limited to a periodic waveform, and may be a non-periodic waveform. The wobble amplitude of the wobbled track T is selected to be, for example, about ±10 nm.

The structures 4 in the space of two tracks T adjacent to each other are arranged to be deviated, for example, by a half of the pitch. Specifically, at the middle positions (the position deviated by a half of the pitch) of the structures 4 arranged in one track (for example T1) of the two tracks T adjacent to each other, the structures 4 of the other track (for example T2) are arranged. As a result, as shown in FIG. 3B, the structures 4 are arranged to form the hexagonal lattice pattern or the quasi-hexagonal lattice pattern in which the centers of the structures 4 are located at the respective points a1 to a7 among the three columns of the tracks (T1 to T3) adjacent to one another.

Here, the hexagonal lattice is defined as a lattice having a regular hexagonal shape. The quasi-hexagonal lattice is different from the lattice having a regular hexagonal shape, and is defined as a lattice having a distorted regular hexagonal shape. For example, when the structures 4 are arranged in straight lines, the quasi-hexagonal lattice is defined as a hexagonal lattice which is distorted by stretching the lattice having the regular hexagonal shape in a linear array direction (a track direction). When the structures 4 are arranged in a staggered manner, the quasi-hexagonal lattice is defined as a hexagonal lattice which is distorted by the staggered array of the structures 4, or is defined as a hexagonal lattice which is distorted by stretching the lattice having the regular hexagonal shape in the linear array direction (the track direction) and is distorted by the staggered array of the structures 4.

When the structures 4 are arranged to form a quasi-hexagonal lattice pattern, as shown in FIG. 3B, it is preferable that the array pitch P1 (for example, the distance between a1 to a2) of the structures 4 in the same track (for example, T1) should be longer than the array pitch of the structures 4 in the space of the two adjacent tracks (for example, T1 and T2), that is, the array pitch P2 (for example, the distance between a1 to a7 and a2 to a7) of the structures 4 in the ±θ direction relative to the track extension direction. By arranging the structures 4 in such a manner, it is possible to further improve the filling density of the structures 4.

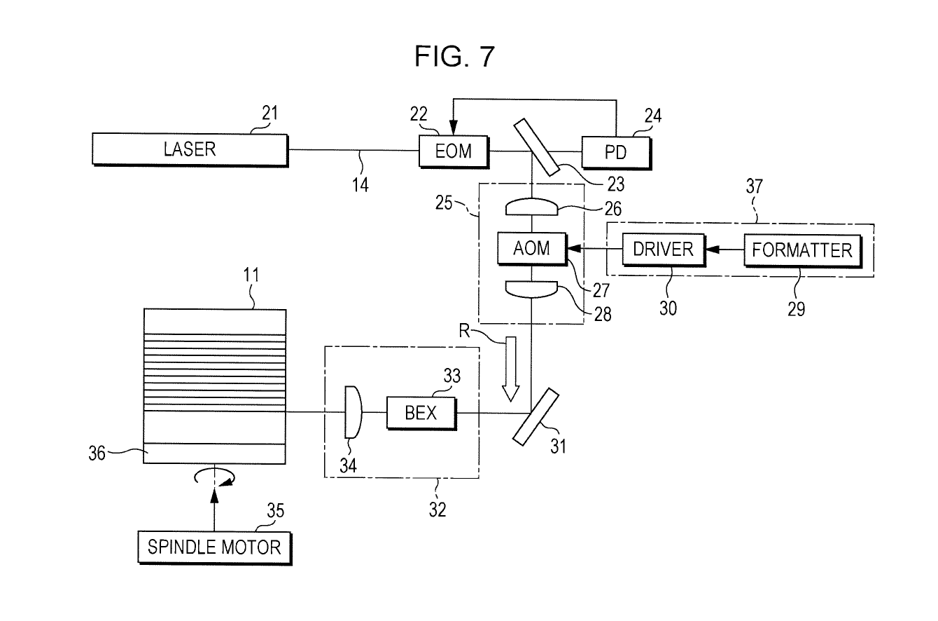

Examples of the specific shape of the structure 4 include a conic shape, a columnar shape, a needle shape, a hemispherical shape, a semi-elliptical shape, a polygonal shape, and the like, but are not limited to the shapes, and may include other shapes. Examples of the conic shape include a conic shape of which the apex is sharp, a conic shape of which the apex is planar, and a conic shape of which the apex is a curved surface having a convex shape or a concave shape. Thus, from the view point of the electric reliability, the conic shape, of which the apex is a curved surface having a convex shape, is preferable, but the conic shape is not limited to the examples. Examples of the conic shape, of which the apex is a curved surface having a convex shape, include a 2nd-order curved surface shape such as a parabolic shape and the like. Further, the conical surface of the conic shape may be curved in a concave shape or a convex shape. When a roll master mold is produced by using an apparatus for exposing the roll mater disk (refer to FIG. 7) to be described later, it is preferable that, by employing, as the shape of the structure 4, an elliptical cone shape of which the apex is a curved surface having a convex shape or an elliptical frustum shape of which the apex is planar, the major axis direction of the elliptical shape forming the bottom face should coincide with the track extension direction T.

In terms of improving the optical adjustment function, the conic shape, in which the inclination at the apex is gentle and the inclination becomes gradually steeper from the center portion to the bottom portion, is preferable. Further, in terms of improving the optical adjustment function of the reflection and transmission characteristics, a conic shape, in which the inclination at the center portion is steeper than that at the bottom portion and the apex, or a conic shape, of which the apex is planar, is preferable. When the structure 4 has an elliptical cone shape or an elliptical frustum shape, it is preferable that the major axis direction of the bottom face should be parallel with the track extension direction.

It is preferable that the structure 4 should have a curved surface portion 4b, in which the height gently decreases in the direction from the apex to the lower portion, in the circumferential portion of the bottom portion. The reason is that, in the process of manufacturing the transparent conductive element 1, it is possible to easily exfoliate the transparent conductive element 1 from the master mold. In addition, the curved surface portion 4b may be provided on only a part of the circumferential portion of the structure 4. However, in terms of improving the exfoliation characteristic, it is preferable to provide the curved surface portion on the entire circumferential portion of the structure 4.

It is preferable that a protrusion portion 4a should be provided on a part or the entirety of the circumferential portion of the structure 4. The reason is that, in such a manner, it is possible to keep the reflectance low even when the filling rate of the structures 4 is low. In terms of ease of formation, it is preferable that the protrusion portions 4a should be provided between the structures 4 neighbored to each other. Further, by roughing a part or the entirety of the surface in the periphery of the structure 4, fine concavity and convexity may be formed. Specifically, for example, by roughing the surface between structures 4 neighbored to each other, fine concavity and convexity may be formed. Further, a minute hole may be formed on the surface of the structure 4, for example, the apex thereof.

In addition, in FIGS. 3B and 3C, each structure 4 has the same size, shape, and height, but the shape of the structure 4 is not limited to this, and the structures 4 having two or more different sizes, shapes, and heights may be formed on the base substance surface.

It is preferable that the height H1 of the structure 4 in the track extension direction should be smaller than the height H2 of the structure 4 in the column direction. That is, it is preferable that the heights H1 and H2 of the structure 4 should satisfy the relationship of H1<H2. The reason is that, when the structures 4 are arranged to satisfy the relationship of H1≧H2, it is necessary to elongate the array pitch P1 in the track extension direction, and the filling rate of the structures 4 in the track extension direction is lowered. As described above, when the filling rate is lowered, the optical adjustment function deteriorates.

In addition, the aspect ratios of the structures 4 are not limited to the case where they are all the same, and may be set such that the respective structures 4 have regular height distribution. By providing the structures 4 having the height distribution, it is possible to reduce the wavelength dependency of the optical adjustment function. Accordingly, it is possible to embody the transparent conductive element 1 having an excellent optical adjustment function.

Here, the height distribution means that the structures 4 having two or more different heights is provided on the surface of the base substance 3. For example, the structures 4 having a reference height and the structures 4 having a height different from the reference height of the structures 4 may be provided on the surface of the base substance 3. In this case, the structures 4 having a height different from the reference is, for example, periodically or non-periodically (randomly) provided on the surface of the base substance 3. Examples of the direction of the periodicity include the track extension direction, the column direction, and the like.

The average array pitch Pm, the average height Hm, and the aspect ratio (average height or average depth Hm/average array pitch Pm) of the structures 4 are respectively the same as the average wavelength λm of the wave surface Sw, the average width Am of the oscillation, and the ratio (the average width Am of the oscillation/average wavelength λm).

It is preferable that, assuming that the array pitch of the structures 4 in the same track is P1 and the array pitch of the structures 4 in the space of the two adjacent tracks is P2, the ratio of P1/P2 should satisfy the relationship of 1.00≦P1/P2≦1.1 or 1.00<P1/P2≦1.1. By setting such a numerical range, a numerical range, it is possible to improve the filling rate of the structures 4 which have an elliptical cone shape or an elliptical frustum shape. Therefore, it is possible to improve the optical adjustment function.

The ratio Rₛ ((S2/S1)×100) of the area S2 of the planar portion to the area S1 of the wave surface Sw is in the range of preferably 0% or more and 50% or less, more preferably 0% or more and 45% or less, and further more preferably 0% or more and 30% or less. By setting the area ratio Rₛ to 50% or less, it is possible to improve the optical adjustment function.

Here, the ratio Rₛ ((S2/S1)×100) of the area S2 of the planar portion to the area S1 of the wave surface Sw is a value obtained in the following manner.

First, the surface of the transparent conductive element 1 is photographed by using the scanning electron microscope (SEM) as viewed from the top. Subsequently, from the taken SEM picture, the unit cell Uc is randomly selected, and the array pitch P1 and the track pitch Tp of the unit cell Uc are measured (refer to FIG. 3B). Further, the area S (structure) of the bottom face of the structure 4 located at the unit cell Uc is measured by image processing. Next, by using the measured array pitch P1, track pitch Tp, and area S (structure) of the bottom face, the ratio R is calculated from the following expression.

Ratio R=[(S(lattice)−S(structure))/S(lattice)]×100

Unit cell area: S(lattice)=P1×2Tp

Area of bottom face of structure existing in unit cell: S(structure)=2S

Processing of calculating the above mentioned ratio R is performed on the unit cells Uc at 10 locations randomly selected from the taken SEM picture. Then, by simply averaging (arithmetically averaging) the measured values, the average ratio of the ratios R is calculated, and is referred to as a ratio Rₛ.

For the filling rate at the time the structures 4 overlap or at the time the substructures such as the protrusion portions 4 and the like are present between the structures 4, the ratio Rₛ can be calculated in a method of determining the area ratio by setting a portion corresponding to a 5% height relative to the height of the structure 4 to a threshold value.

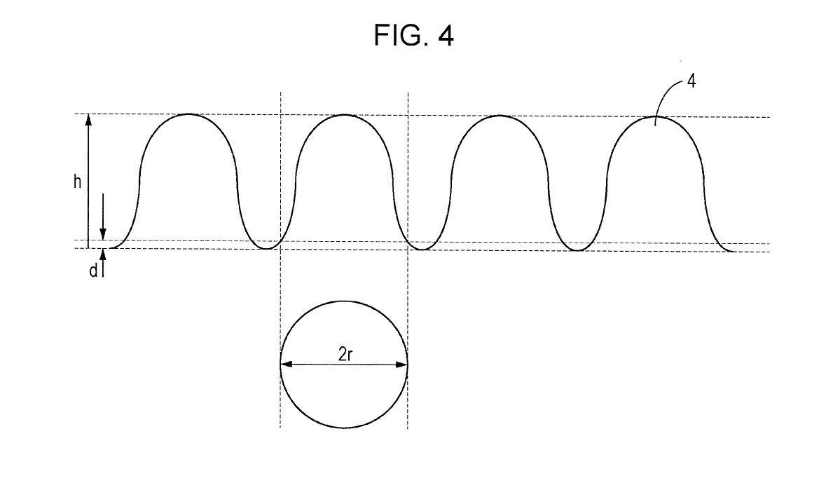

FIG. 4 is a diagram illustrating a method of calculating the ratio Rₛ when the boundaries of the structures 4 are not clear. When the boundaries of the structures 4 is not clear, through sectional SEM observation, as shown in FIG. 4, the portion corresponding to 5% (=(d/h)×100) of the height h of the structure 4 is set to a threshold value, and the radius of the structure 4 is converted by the height d, thereby obtaining the ratio Rₛ. When the bottom face of each structure 4 is elliptical, the same processing is performed in terms of the major axis and the minor axis.

It is preferable that the structures 4 should be connected such that the lower portions thereof overlap each other. Specifically, it is preferable that the lower portions of a part or the entirety of the structures 4 should overlap each other, and it is preferable that the lower portions should overlap each other in the track direction, the θ direction, or the both directions thereof. As described above, by overlapping the lower portions of the structures 4 with each other, it is possible to improve the filling rate of the structures 4. It is preferable that the structures should overlap each other at the portions thereof corresponding to ¼ or less of the maximum value of the wavelength band of light under usage environment at the optical path length in which the refractive index is considered. The reason is that, in such a manner, it is possible to obtain an excellent optical adjustment function.

The ratio ((2r/P1)×100) of the radius 2r to the array pitch P1 is in the range of preferably 85% or more, more preferably 90% or more, and further more preferably 95% or more. By setting such a range, it is possible to improve the filling rate of the structures 4 and improve the optical adjustment function. When the ratio ((2r/P1)×100) is set to be large and the overlap of the structures 4 is too large, the optical adjustment function tends to deteriorate. Accordingly, it is preferable to set the upper limit of the ratio ((2r/P1)×100) so as to bond the structures to each other at the portions thereof corresponding to ¼ or less of the maximum value of the wavelength band of light under usage environment at the optical path length in which the refractive index is considered. Here, the array pitch P1 is, as shown in FIG. 3B, the array pitch of the structures 4 in the track direction, and the radius 2r is, as shown in FIG. 3B, the radius of the structure bottom face in the track direction. In addition, when the structure bottom face has a circular shape, the radius 2r is a diameter, and when the structure bottom face has an elliptical shape, the radius 2r is a length of the major axis.

When the structures 4 form the quasi-hexagonal lattice pattern, it is preferable that the ellipticity e of the structure bottom face should be 100%<e<150% or less. By setting this range, it is possible to improve the filling rate of the structures 4, and it is possible to obtain an excellent optical adjustment function.

(Transparent Conductive Layer)

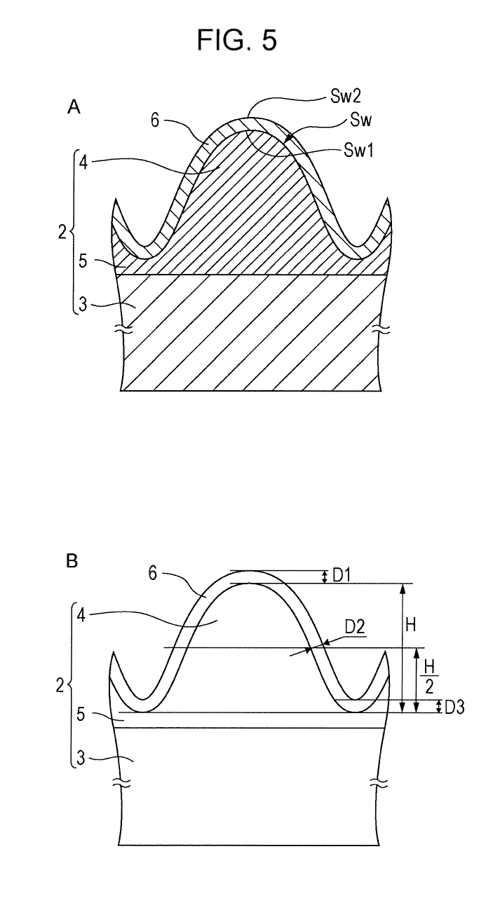

FIG. 5A is an enlarged sectional view illustrating an example of a surface shape of the transparent conductive layer. The transparent conductive layer 6 has the first wave surface Sw1 and the second wave surface Sw2 which are synchronous to each other. It is preferable that the average widths of the oscillations between the first wave surface Sw1 and the second wave surface Sw2 should be different. It is preferable that the average width A1 of the oscillation of the first wave surface Sw1 should be smaller than the average width A2 of the oscillation of the second wave surface Sw2. Examples of the sectional shape of the first wave surface Sw1 or second wave surface Sw2, which is cut in one direction so as to include the position where the width of the oscillation is maximized, include a triangular wave shape, a sine wave shape, a shape of a 2nd-order curve or a part of the 2nd-order curve which is repeated, a shape approximated thereto, and the like. Examples of the 2nd-order curve include a circle, an ellipse, and a parabola.

The transparent conductive layer 6 is, for example, an organic transparent conductive layer or an inorganic transparent conductive layer. It is preferable that the organic transparent conductive layer should consist primarily of a conductive polymer or a carbon nanotube. As the conductive polymer, conductive polymer materials such as a polythiophene series, a polyaniline series, and a polypyrrole series may be used, and it is preferable to use the conductive polymer material of the polythiophene series. As the conductive polymer material of the polythiophene series, it is preferable to use a material of a PEDOT/PSS series in which PSS (polystyrene sulfonic acid) is doped to PEDOT (polyethylene dioxythiophene).

It is preferable that the inorganic transparent conductive layer should consist primarily of a transparent oxide semiconductor. As the transparent oxide semiconductor, for example, binary compounds such as SnO₂, InO₂, ZnO, and CdO and ternary compounds including at least one element of Sn, In, Zn, and Cd which are constituent elements of the binary compounds, or multi-element-based (complex) oxides may be used. Specific examples of the transparent oxide semiconductor include indium tin oxide (ITO), zinc oxide (ZnO), aluminum-doped zinc oxide (AZO (Al₂O₃, ZnO)), SZO, fluorine-doped tin oxide (FTC)), tin oxide (SnO₂), gallium-doped zinc oxide (GZO), indium zinc oxide (IZO (In₂O₃, ZnO)), and the like. In particular, from the viewpoint of high reliability and low resistivity, the indium tin oxide (ITO) is preferable. It is preferable that the material constituting the inorganic transparent conductive layer should be in a state of mixture between amorphous and poly crystal.

From the viewpoint of productivity, it is preferable that the material constituting the transparent conductive layer 6 should consist primarily of at least one selected from the groups formed of a conductive polymer, metallic nanoparticles, and carbon nanotubes. By using such materials as main components, it is possible to easily form the transparent conductive layer 6 through wet coating without using the expensive vacuum apparatus and the like.

FIG. 5B is an enlarged sectional view illustrating the film thickness of the transparent conductive layer. As shown in FIG. 5B, assuming that the film thickness of the transparent conductive layer 6 at the apex of the structure 4 is D1, the film thickness of the transparent conductive layer 6 on the inclined surface of the structure 4 is D2, and the film thickness of the transparent conductive layer 6 between the structures is D3, the film thicknesses D1, D2, and D3 satisfy preferably the relationship of D1>D3 and more preferably the relationship of D1>D3>D2. The ratio (D3/D1) of the film thickness D3 of the transparent conductive layer 6 between the structures to the film thickness D1 of the transparent conductive layer 6 at the apex of the structure 4 is in the range of preferably 0.8 or less, and more preferably 0.7 or less. By setting the ratio (D3/D1) to 0.8 or less, as compared with a case where the ratio (D3/D1) is set to 1, it is possible to improve the optical adjustment function. Accordingly, it is possible to reduce the reflectance difference ΔR between the first region R₁, in which the transparent conductive layer 6 is formed, and the second region R₂ in which the transparent conductive layer 6 is not formed. That is, it is possible to prevent the transparent conductive layer 6 with the prescribed pattern from being visible.

In addition, the film thickness D1 of the transparent conductive layer 6 at the apex of the structure 4, the film thickness D2 of the transparent conductive layer 6 on the inclined surface of the structure 4, and the film thickness D3 of the transparent conductive layer 6 between the structures are respectively the same as the film thickness D1 of the transparent conductive layer 6 at the position where the wave surface Sw is highest, the film thickness D2 of the transparent conductive layer 6 on the inclined surface of the wave surface Sw, and the film thickness D3 of the transparent conductive layer 6 at the position where the wave surface Sw is lowest.

The film thickness D1 of the transparent conductive layer 6 at the apex of the structure 4 is in the range of preferably 100 nm or less, more preferably 10 nm or more and 100 nm or less, further more preferably 10 nm or more and 80 nm or less. If the thickness is greater than 100 nm, the visibility tends to deteriorate. In contrast, if the thickness is less than 10 nm, the electric characteristics tend to deteriorate.

The above-mentioned film thicknesses D1, D2, and D3 of the transparent conductive layer 6 are obtained in the following manner.

First, the transparent conductive element 1 is cut in the track extension direction so as to include the apex of the structure 4, thereby photographing the section thereof through TEM. Next, from the taken TEM picture, the film thickness D1 of the transparent conductive layer 6 at the apex of the structure 4 is measured. Subsequently, the film thickness D2 at the position of a half of the height (H/2) of the structure 4 among the positions on the inclined surface of the structure 4 is measured. Then, the film thickness D3 at the position, in which the depth of the concave portion is largest, among the positions on the concave portion between the structures is measured.

In addition, it is possible to check whether or not the film thicknesses D1, D2, and D3 of the transparent conductive layer 6 have the relationship on the basis of the film thicknesses D1, D2, and D3 of the transparent conductive layer obtained in such a manner.

The surface resistance of the transparent conductive layer 6 is in the range of preferably 50Ω/□ or more and 4000Ω/□ or less, and more preferably 50Ω/□ or more and 500Ω/□ or less. The reason is that, by setting the surface resistance in the ranges, the transparent conductive element 1 can be used as the upper electrode or the lower electrode of the capacitive touch panel. Here, the surface resistance of the transparent conductive layer 6 is obtained by the four-point probe method (JIS K 7194). It is preferable that the specific resistance of the transparent conductive layer 6 should be 1×10⁻³ Ω·cm or less. The reason is that, if the specific resistance is 1×10⁻³ Ω·cm or less, it is possible to achieve the surface resistance range.

(Pasting Layer)

The paste layer 8 may employ, for example, adhesives of an acryl series, a rubber series, a silicon series, and the like. From the viewpoint of the transparency, the adhesive of the acryl series is preferable.

### [Configuration of Roll Master Mold]

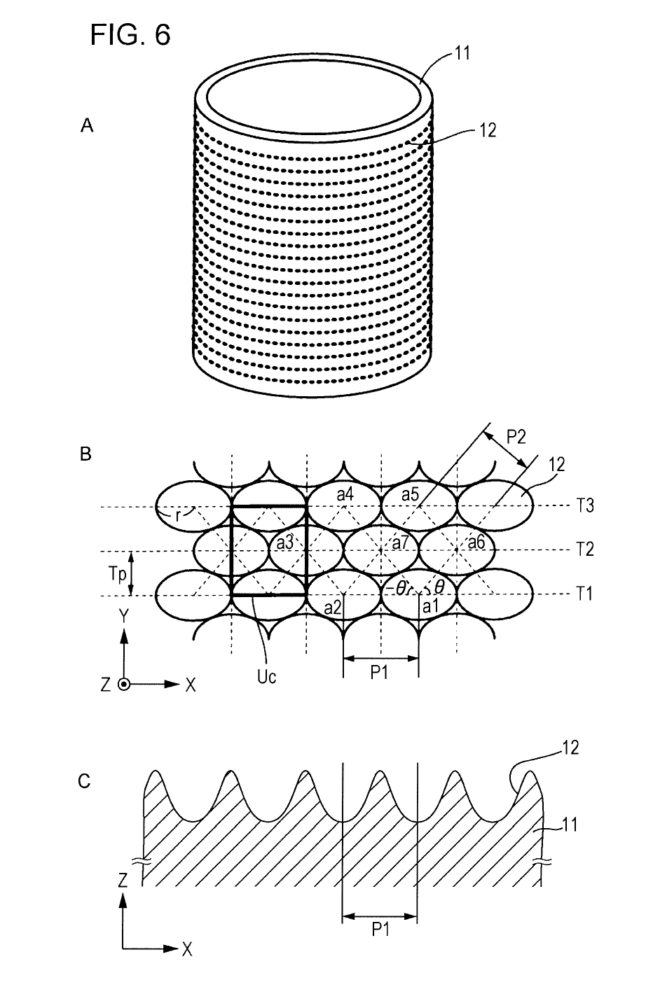

FIG. 6A is a perspective view illustrating an example of a configuration of a roll master mold. FIG. 6B is a top plan view illustrating a part of the roll master mold shown in FIG. 6A in an enlarged manner. FIG. 6C is a sectional view of the tracks T1, T3, . . . of FIG. 6B. The roll master mold 11 is a master mold for producing the transparent conductive element 1 having the above-mentioned configuration, and is more specifically a master mold for molding a plurality of structures 4 on the above-mentioned base substance surface. The roll master mold 11 has, for example, a columnar shape or a cylindrical shape, the columnar surface or cylindrical surface serves as a molding surface for molding the plurality of structures 4 on the base substance surface. The plurality of structures 12 are two-dimensionally arranged on the molding surface. Each structure 12 has, for example, a concave shape on the molding surface. As the material of the roll master mold 11, for example, glass may be used, but the material is not limited to this.

The plurality of structures 12, which are arranged on the molding surface of the roll master mold 11, and the plurality of structures 4, which are arranged on the above-mentioned the surface of the base substance 3, have a reversed concave and convex relationship. That is, the shape, the array, the array pitch, and the like of the structures 12 of the roll master mold 11 are the same as the structures 4 on the base substance 3.

### [Configuration of Exposure Apparatus]

FIG. 7 is a schematic view illustrating an example of a configuration of an apparatus for exposing the roll mater disk. The apparatus for exposing the roll mater disk is formed by making an apparatus for recording the optical disk as a base.

A laser light source 21 is a light source for exposing a resist coated on the surface of the master mold roll 11 as a recording medium, and generates laser light 14 for recording with, for example, a wavelength λ of 266 nm. The laser light 14, which exits from the laser light source 21, travels as a parallel beam in a straight line, and is incident to an electro-optic element (EOM: Electro Optical Modulator) 22. The laser light 14, which is transmitted through the electro-optic element 22, is reflected by a mirror 23, and is guided to a modulated optical system 25.

The mirror 23 is formed as a polarized beam splitter, and thus has a function of reflecting a polarized light component in one direction and transmitting a polarized light component in the other direction. The polarized light component, which is transmitted through the mirror 23, is received by the photodiode 24, and the electro-optic element 22 is controlled on the basis of the received light signal, thereby performing phase modulation of the laser light 14.

In the modulated optical system 25, the laser light 14 is concentrated onto an acousto-optic element (AOM: Acousto-Optic Modulator) 27 made of glass (SiO₂) or the like through a condensing lens 26. The laser light 14 is intensity-modulated and diverged by the acousto-optic element 27, and is converted into a parallel beam through a lens 28. The laser light 14, which exits from the modulated optical system 25, is reflected by the mirror 31, and is guided horizontally and parallel onto a movable optical table 32.

The movable optical table 32 has a beam expander 33 and an objective lens 34. The laser light 14, which is guided to the movable optical table 32, is shaped into a desirable beam shape through a beam expander 33, and then irradiates the resist layer on the roll master mold 11 through the objective lens 34. The roll master mold 11 is placed on a turntable 36 which is connected to a spindle motor 35. Then, by intermittently irradiating the resist layer with the laser light 14 while rotating the roll master mold 11 and moving the laser light 14 in the direction of the height of the roll master mold 11, the process of exposing the resist layer is performed. The formed latent image has a substantially elliptical shape having the major axis in the circumferential direction. The laser light 14 is moved by the movement in the direction of the arrow R of the movable optical table 32.

The exposure apparatus has a control mechanism 37 for forming the latent image, which corresponds to a two-dimensional pattern of the hexagonal lattice or the quasi-hexagonal lattice shown in FIG. 3B, on the resist layer. The control mechanism 37 has a formatter 29 and a driver 30. The formatter 29 has a polarity reversion section, and controls timing of irradiating the resist layer with the laser light 14. The driver 30 receives the output of the polarity reversion section, and controls the acousto-optic element 27.

In the apparatus for exposing the roll mater disk, a polarity reversion formatter signal is synchronized with a rotary controller for each one track such that the two-dimensional patterns are spatially linked, thereby generating a signal and intensity modulating the signal through the acousto-optic element 27. By patterning at an appropriate modulation frequency and at an appropriate feed pitch at a constant angular velocity (CAV), it is possible to record the hexagonal lattice or quasi-hexagonal lattice pattern.

### [Method of Producing Transparent Conductive Element]

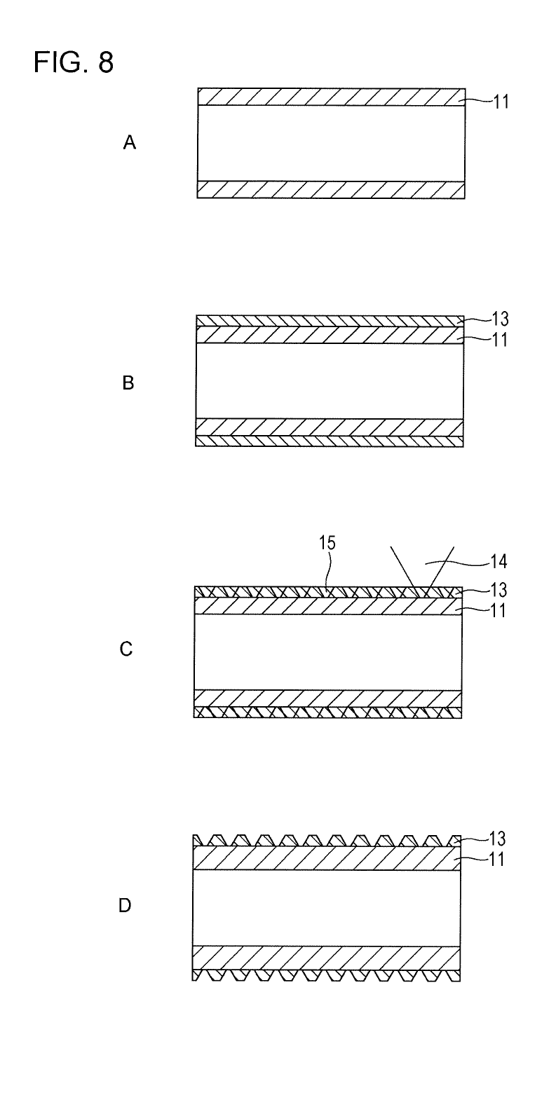

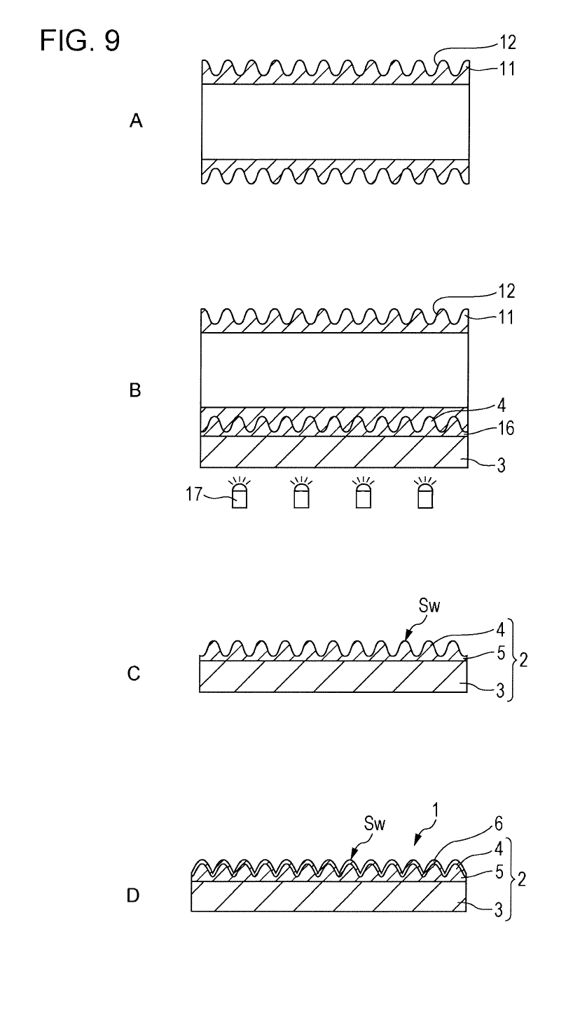

Next, referring to FIGS. 8A to 9D, a method of producing the transparent conductive element according to the first embodiment of the present invention 1 will be described.

(Resist Film Formation Process)

First, as shown in FIG. 8A, a columnar or cylindrical roll master mold 11 is provided. The roll master mold 11 is, for example, a glass master mold. Next, as shown in FIG. 8B, the resist layer 13 is formed on the surface of the roll master mold 11. As the material of the resist layer 13, for example, either one of an organic resist and an inorganic resist may be used. As the organic resist, for example, a novolac-based resist or a chemically-amplified resist may be used. Further, as the inorganic resist, for example, a metallic compound including one or two or more kinds.

(Exposure Process)

Next, as shown in FIG. 8C, the laser light (exposure beam) 14 is illuminated on the resist layer 13 which is formed on the surface of the roll master mold 11. Specifically, the laser light is placed on the turntable 36 of the apparatus for exposing the roll mater disk shown in FIG. 7, the roll master mold 11 is rotated, and the laser light (exposure beam) 14 is illuminated on the resist layer 13. At this time, by intermittently illuminating the laser light 14 while moving the laser light 14 in the direction of the height of the roll master mold 11 (the direction which is parallel with the center axis of the columnar or cylindrical roll master mold 11), the resist layer 13 is exposed throughout the entire surface. Thereby, the latent image 15 corresponding to the locus of the laser light 14 is formed throughout the entire surface of the resist layer 13 at a pitch substantially equal to, for example, the visible light wavelength.

The latent image 15 is, for example, disposed so as to form the plurality of columns of tracks on the roll master mold surface, and forms a hexagonal lattice pattern or a quasi-hexagonal lattice pattern. The latent image 15 has, for example, an elliptical shape of which the major axis direction is the track extension direction.

(Development Process)

Next, for example, by dripping developing liquid onto the resist layer 13 while rotating the roll master mold 11, a development treatment is performed on the resist layer 13. Thereby, as shown in FIG. 8D, a plurality of opening portions are formed on the resist layer 13. When the resist layer 13 is formed by a positive-type resist, the rate of solution of the developing liquid in the portion exposed by the laser light 14 is higher than that in the unexposed portion. Therefore, as shown in FIG. 8D, a pattern corresponding to the latent image (the exposed portion) 16 is formed on the resist layer 13. The pattern of the opening portions is, for example, a prescribed lattice pattern such as a hexagonal lattice pattern or a quasi-hexagonal lattice pattern.

(Etching Process)

Next, by using the pattern (the resist pattern) of the resist layer 13 formed on the roll master mold 11 as a mask, an etching treatment is performed on the surface of the roll master mold 11. Thereby, as shown in FIG. 9A, it is possible to obtain concave portions each having an elliptical cone shape or an elliptical frustum shape of which the major axis direction is the track extension direction, that is, the structures 12. As the etching, for example, dry etching or wet etching may be used. At this time, by alternately performing the etching process and the ashing process, it is possible to form a pattern of the structures 12 each having, for example, a conic shape.

As described above, it is possible to obtain the desirable roll master mold 11.

(Transfer Process)

Next, as shown in FIG. 9B, the roll master mold 11 is made to be in close contact with a transfer material 16 with which the base substance 3 is coated, subsequently energy beams such as ultraviolet rays are illuminated from an energy beam source 17 onto the transfer material 16 so as to thereby cure the transfer material 16, and then the base substance 3 integrated with the cured transfer material 16 is exfoliated therefrom. Thereby, as shown in FIG. 9C, the optical layer 2, which has the plurality of structures 4 provided on the base substance surface, is produced.

The energy beam source 17 is not especially limited if it is able to discharge energy beams such as electron beams, ultraviolet rays, infrared rays, laser beams, visible rays, ionizing radiation (X ray, α ray, β ray, γ ray, and the like), microwaves, or high-frequency waves.

As the transfer material 16, it is preferable to use an energy beam curable resin composition. As the energy beam curable resin composition, it is preferable to use an ultraviolet curable resin composition. The energy beam curable resin composition may include a filler or a functional additive as necessary.

The ultraviolet curable resin composition includes, for example, acrylate and an initiator. The ultraviolet curable resin composition includes, for example, a monofunctional monomer, a bifunctional monomer, a multifunctional monomer, and the like, and is one of the materials shown below or a mixture of the plural materials.

Examples of the monofunctional monomer include: calboxylic acid series (acrylic acid); hydroxyl series (2-hydroxy ethyl acrylate, 2-hydroxy propyl acrylate, 4-hydroxy butyl acrylate); alkyl, alicyclic series (isobutyl acrylate, t-butyl acrylate, isooctyl acrylate, lauryl acrylate, stearyl acrylate, isobonyl acrylate, cyclohexyl acrylate); other functional monomers (2-methoxy ethyl acrylate, methoxy ethylene glycol acrylate, 2-ethoxy ethyl acrylate, tetrahydro furfuryl acrylate, benzil acrylate, ethyl carbitol acrylate, phenoxy ethyl acrylate, N,N-dimethyl aminoethyl acrylate, N,N-dimethyl aminopropyl acryl amide, N,N-dimethyl acryl amide, acryloyl morpholine, N-isopropyl acryl amide, N,N-diethyl acryl amide, N-vinyl pyrolidone, 2-(perfluorooctyl)ethyl acrylate, 3-perfluorohexyl-2-hydroxy propyl acrylate, 3-perfluorooctyl-2-hydroxy propyl acrylate, 2-(perfluorodecyl)ethyl acrylate, 2-(perfluoro-3-methyl butyl)ethyl acrylate), 2,4,6-tri bromophenol acrylate, 2,4,6-tri bromophenol methacrylate, 2-(2,4,6-tri bromophenoxy)ethyl acrylate); 2-ethyl hexyl acrylate; and the like.

Examples of the bifunctional monomer include tri(propylene glycol)diacrylate, trimethylol propane diallyl ether, urethane acrylate, and the like.

Examples of the multifunctional monomer include trimethylol propane triacrylate, dipentaerythritol penta and hexa acrylate, ditrimethylol propanetetraacrylate, and the like.

Examples of the initiator include 2,2-dimethoxy-1,2-diphenyl ethane-1-one, 1-hydroxy-cyclohexyl phenyl ketone, 2-hydroxy-2-methyl-1-phenyl propane-1-one, and the like.

As the filler, for example, ether one of inorganic microparticulates and organic microparticulates may be used.

Examples of the inorganic microparticulates include microparticulates of metallic oxide such as SiO₂, TiO₂, ZrO₂, SnO₂, or Al₂O₃.

The examples of the functional additive include a leveling agent, a surface conditioner, an antifoamer, and the like. Examples of the material of the base substance 3 include methyl methacrylate (co)polymer, polycarbonate, styrene (co)polymer, methyl methacrylate-styrene copolymer, cellulose diacetate, cellulose triacetate, cellulose acetate butylate, polyester, polyamide, polyimide, polyether sulfone, polysulfone, polypropylene, polymethyl pentene, polyvinyl chloride, polyvinyl acetal, polyether ketone, polyurethane, glass, and the like.

The method of molding the base substance 3 is not especially limited, and may employ an injection compact, an extrusion compact, and a cast compact. As necessary, a surface treatment such as a corona treatment is performed on the base substance surface.

(Process of Forming Transparent Conductive Layer)

Next, as shown in FIG. 9D, the transparent conductive layer 6 is formed on the wave surface Sw of the optical layer 2 on which the plurality of structures 4 are formed. When the transparent conductive layer 6 is formed, the film formation may be performed while the optical layer 2 is heated. As the method of forming the transparent conductive layer 6, the following method may be used, for example: CVD methods (Chemical Vapor Deposition: techniques of precipitating a thin film from the vapor phase by using chemical reaction) such as a thermal CVD, and a plasma CVD, and an optical CVD; and PVD methods (Physical Vapor Deposition: techniques of forming a thin film by condensing a physically gasified material on the substrate in vacuum) such as vacuum deposition, plasma-assisted deposition, sputtering, and ion-plating. Next, as necessary, an annealing treatment is applied to the transparent conductive layer 6. Thereby, the transparent conductive layer 6 achieves, for example, a state of mixture between amorphous and poly crystal.

(Process of Patterning Transparent Conductive Layer)

Next, for example, by patterning the transparent conductive layer 6 through photo-etching, the transparent conductive layer 6 with the prescribed pattern is formed.

In the above-mentioned manner, it is possible to obtain the desirable transparent conductive element 1.

### 2. Second Embodiment

### [Configuration of Transparent Conductive Element]

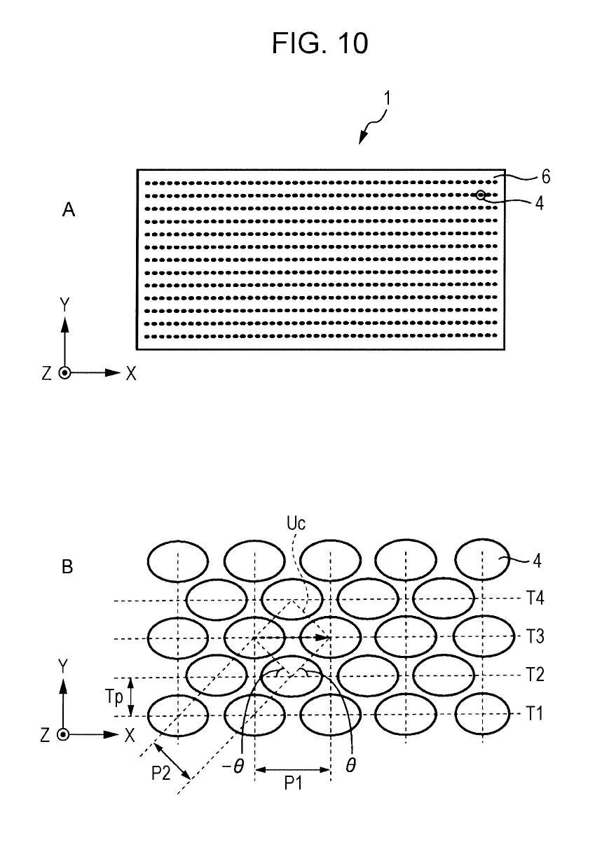

FIG. 10A is a top plan view illustrating an example of an optical layer surface of a transparent conductive element according to a second embodiment of the present invention. FIG. 10B is a top plan view illustrating a part of the optical layer surface shown in FIG. 10A in an enlarged manner. The transparent conductive element 1 according to the second embodiment is different from that of the first embodiment in that the plurality of structures 4 forms a tetragonal lattice pattern or a quasi-tetragonal lattice pattern in the space of three columns of adjacent tracks T.

Here, the tetragonal lattice is a lattice having a regular tetragonal shape. The quasi-tetragonal lattice is different from the lattice having a regular tetragonal shape, and is defined as a lattice having a distorted regular tetragonal shape. For example, when the structures 4 are arranged in straight lines, the quasi-tetragonal lattice is defined as a tetragonal lattice which is distorted by stretching the lattice having the regular tetragonal shape in a linear array direction (the track direction). When the structures 4 are arranged in a staggered manner, the quasi-tetragonal lattice is defined as a tetragonal lattice which is distorted by the staggered array of the structures 4. Alternatively, the quasi-tetragonal lattice is defined as a tetragonal lattice which is distorted by stretching the lattice having the regular tetragonal shape in the linear array direction (the track direction) and is distorted by the staggered array of the structures 4.

It is preferable that the array pitch P1 of the structures 4 in the same track should be longer than the array pitch P2 of the structures 4 in the space of the two adjacent tracks. Further, it is preferable that, assuming that the array pitch of the structures 4 in the same track is P1 and the array pitch of the structures 4 in the space of the two adjacent tracks is P2, the ratio of P1/P2 should satisfy the relationship of 1.4<P1/P2≦1.5. By setting such a numerical range, it is possible to improve the filling rate of the structures 4 which have an elliptical cone shape or an elliptical frustum shape. Therefore, it is possible to improve the optical adjustment function. Further, it is preferable that the height or the depth of the structure 4 in the direction of 45 degrees or the direction of about 45 degrees with respect to the track should be smaller than the height or the depth of structure 4 in the track extension direction.

It is preferable that the height H2 of the structure 4 in the array direction (the θ direction) tilted to the track extension direction should be smaller than the height H1 of the structure 4 in the track extension direction. That is, it is preferable that the heights H1 and H2 of the structure 4 should satisfy the relationship of H1>H2.

When the structures 4 form a tetragonal lattice or a quasi-tetragonal lattice pattern, it is preferable that the ellipticity e of the structure bottom face should be 150%≦e≦180%. By setting this range, it is possible to improve the filling rate of the structures 4, and it is possible to obtain an excellent optical adjustment function.

The ratio Rₛ ((S2/S1)×100) of the area S2 of the planar portion to the area S1 of the wave surface Sw is in the range of preferably 0% or more and 50% or less, more preferably 0% or more and 45% or less, and further more preferably 0% or more and 30% or less. By setting the area ratio Rₛ to 50% or less, it is possible to improve the optical adjustment function.

Here, the ratio Rₛ ((S2/S1)×100) of the area S2 of the planar portion to the area S1 of the wave surface Sw is a value obtained in the following manner.

First, the surface of the transparent conductive element 1 is photographed by using the scanning electron microscope (SEM) as viewed from the top. Subsequently, from the taken SEM picture, the unit cell Uc is randomly selected, and the array pitch P1 and the track pitch Tp of the unit cell Uc are measured (refer to FIG. 10B). Further, the area S (structure) of the bottom face of any one of the four structures 4 included in the unit cell Uc is measured by image processing. Next, by using the measured array pitch P1, track pitch Tp, and area S (structure) of the bottom face, the ratio R is calculated from the following expression.

Ratio R=[(S(lattice)−S(structure))/S(lattice)]×100

Unit Cell Area: S(lattice)=2×((P1×Tp)×(½))=P1×Tp

Area of bottom face of structure existing in unit cell: S(structure)=S

Processing of calculating the above mentioned ratio R is performed on the unit cells Uc at 10 locations randomly selected from the taken SEM picture. Then, by simply averaging (arithmetically averaging) the measured values, the average ratio of the ratios R is calculated, and is referred to as a ratio Rₛ.

The ratio ((2r/P1)×100) of the radius 2r to the array pitch P1 is 64% or more, preferably 69% or more, and more preferably 73% or more. By setting such a range, it is possible to improve the filling rate of the structures 4 and improve the optical adjustment function. Here, the array pitch P1 is the array pitch of the structures 4 in the track direction, and the radius 2r is the radius of the structure bottom face in the track direction. In addition, when the structure bottom face has a circular shape, the radius 2r is a diameter, and when the structure bottom face has an elliptical shape, the radius 2r is a length of the major axis.

According to the second embodiment, it is possible to obtain the same effect as the first embodiment.

### Third Embodiment

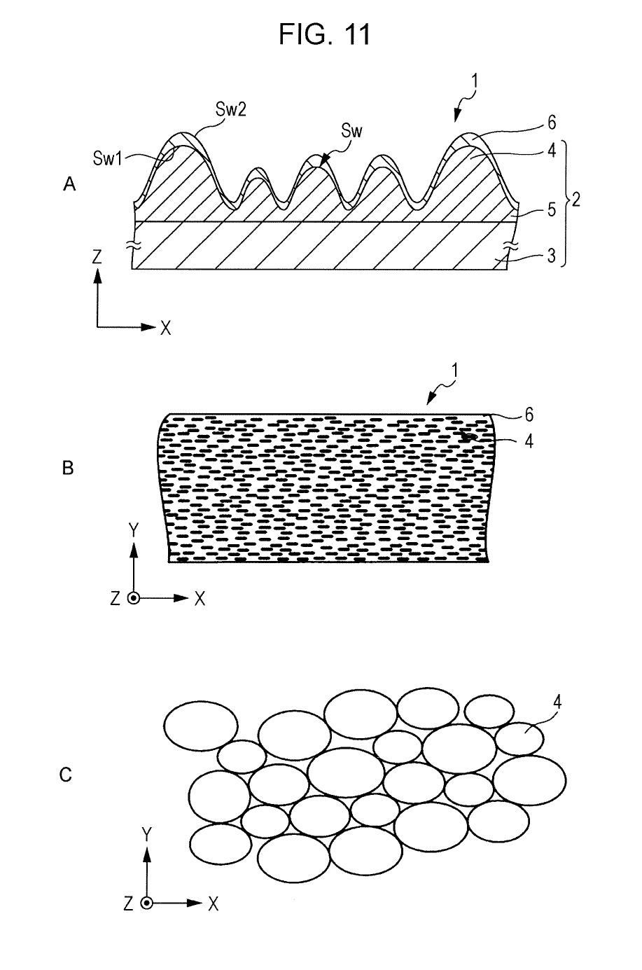

FIG. 11A is a sectional view illustrating an example of a configuration of a transparent conductive element according to a third embodiment of the present invention. FIG. 11B is a top plan view illustrating an example of an optical layer surface of the transparent conductive element according to the third embodiment of the present invention. FIG. 11C is a top plan view illustrating a part of the optical layer surface shown in FIG. 11B in an enlarged manner.

The transparent conductive element 1 according to the third embodiment is different from that of the first embodiment in that the plurality of structures 4 are randomly (irregularly) arranged in a two-dimensional array. Further, at least one of the shape, the size, and the height of the structures 21 may be further randomly changed.

Except the above-mentioned difference, the third embodiment is the same as the first embodiment.

The master mold for producing the transparent conductive element 1 may employ, for example, a method of anodizing a surface of an aluminum base material, but is not limited to this method.

In the third embodiment, the plurality of structures 4 are randomly arranged in a two-dimensional array, and thus it is possible to suppress occurrence of seeming unevenness.

### 4. Fourth Embodiment

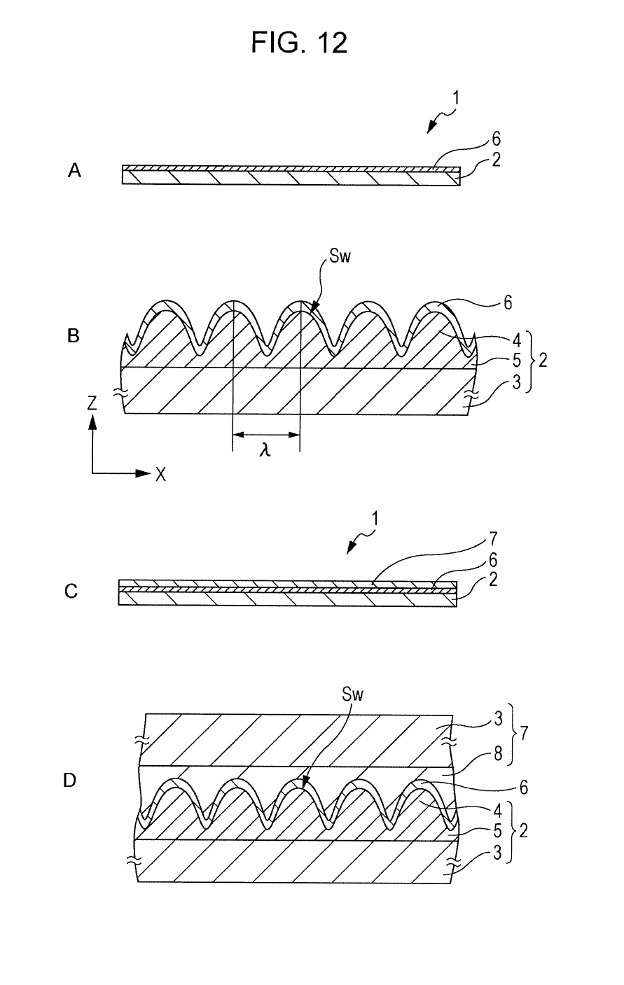

FIG. 12A is a sectional view illustrating an example of a configuration of a transparent conductive element according to a fourth embodiment of the present invention. FIG. 12B is an enlarged sectional view illustrating a part of the optical layer surface shown in FIG. 12A in an enlarged manner. FIG. 12C is a sectional view illustrating another example of the configuration of the transparent conductive element according to the fourth embodiment of the present invention. FIG. 12D is an enlarged sectional view illustrating a part of the optical layer surface shown in FIG. 12C in an enlarged manner.

As shown in FIGS. 12A and 12B, the transparent conductive element 1 according to the fourth embodiment is different from that of the first embodiment in that the transparent conductive layer 6 is continuously formed through substantially the entire wave surface Sw of the optical layer (the first optical layer) 2.

Further, if necessary, as shown in FIGS. 12C and 12D, by further providing the optical layer (second optical layer) 7 which is formed on the transparent conductive layer 6, both principal surfaces of the transparent conductive layer 6 are configured to be respectively covered by the optical layer 2 and the optical layer 7. In addition, the directions of the concavity and convexity of the structure 4 may be reversed.

Except the above-mentioned difference, the fourth embodiment is the same as the first embodiment.

### 5. Fifth Embodiment

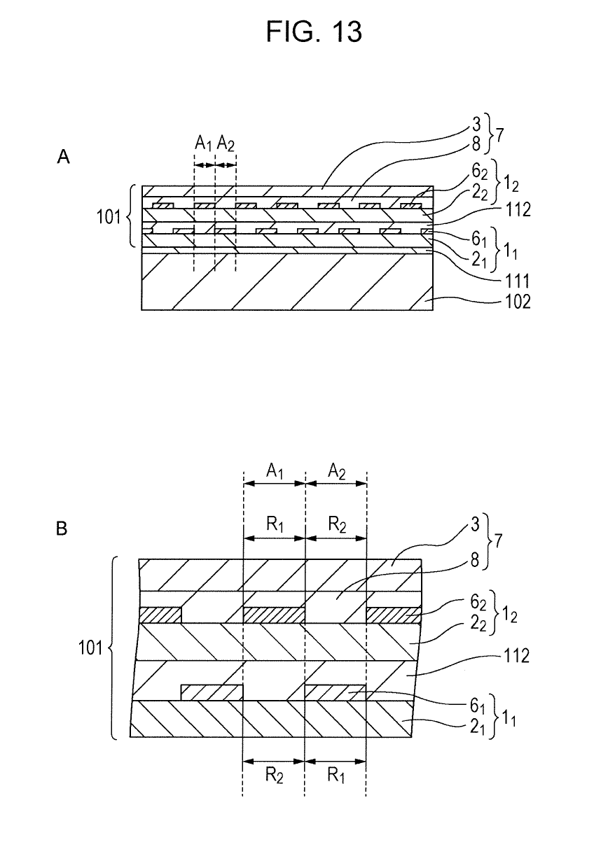

FIG. 13A is a sectional view illustrating an example of a configuration of an information input device according to a fifth embodiment of the present invention. As shown in FIG. 13A, the information input device 101 is provided on the display screen of a display apparatus 102. For example, the information input device 101 is attached to the display screen of the display apparatus 102 through a paste layer 111. The display apparatus 102 employing the information input device 101 is not especially limited. However, examples of the display apparatus include various display apparatuses such as a liquid crystal display, a CRT (Cathode Ray Tube) display, a plasma display (Plasma Display Panel: PDP), an electro luminescence (EL) display, and a surface-conduction electron-emitter display (SED).

The information input device 101 is a so-called projection capacitive touch panel, and includes a first transparent conductive element 1₁, a second transparent conductive layer 1₂ provided on the first transparent conductive element 1₁, and the optical layer 7 provided on the second transparent conductive layer 1₂. The first transparent conductive element 1₁ and the second transparent conductive layer 1₂ are attached to each other through the paste layer 112 such that the surface of the first transparent conductive element 1₁ on the transparent conductive layer 6₁ side is opposed to the surface of the second transparent conductive element 1₂ on the base substance 3 side. The optical layer 7 is formed by attaching the base substance 3 to the surface of the second transparent conductive element 1₂ on the transparent conductive layer 8 side through the paste layer 8.

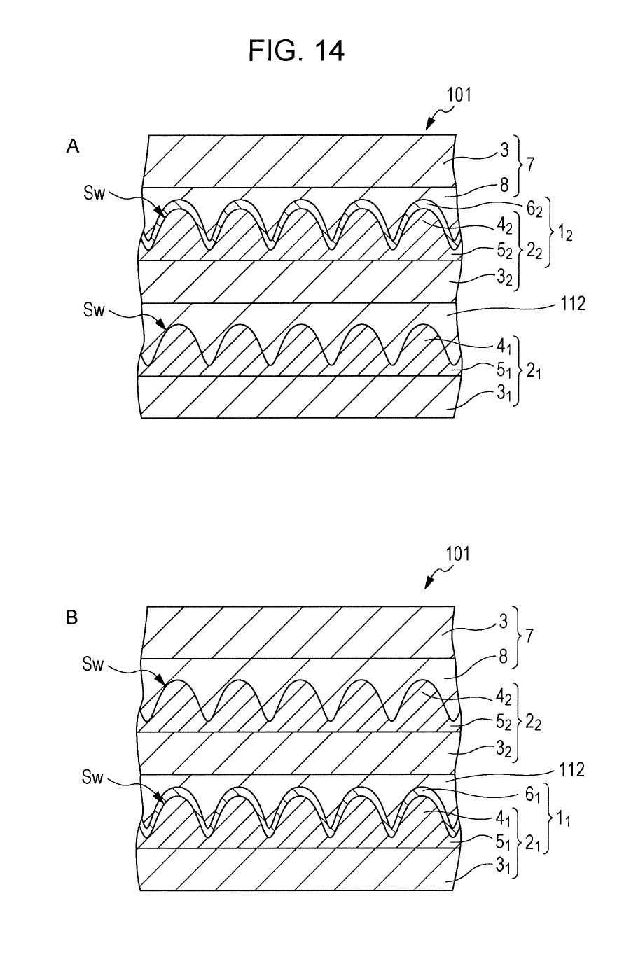

FIG. 13B is an enlarged sectional view illustrating a region A1 and a region A₂ shown in FIG. 13A in an enlarged manner. FIG. 14A is an enlarged sectional view illustrating the region A₁ shown in FIG. 13A in a further enlarged manner. FIG. 14B is an enlarged sectional view illustrating the region A₂ shown in FIG. 13A in a further enlarged manner.

As shown in FIG. 13B, it is preferable that a transparent conductive layer 6₁ of the first transparent conductive element 1₁ and a transparent conductive layer 6₂ of the second transparent conductive element 1₂ should be provided not to overlap each other in the thickness direction of the information input device 101. That is, it is preferable that a first region R₁ of the first transparent conductive element 1₁ and a second region R₂ of the second transparent conductive element 1₂ should overlap each other in the thickness direction of the information input device 101. In addition, it is preferable that a second region R₂ of the second transparent conductive element 1₁ and a first region R₁ of the second transparent conductive element 1₂ should overlap each other in the thickness direction of the information input device 101. In such a manner, it is possible to reduce the difference in transmittance between the first transparent conductive element 1₁ and the second transparent conductive element 1₂ caused by the overlap. In addition, in FIGS. 13A and 13B, as an example, the following case is shown: the directions of the first transparent conductive element 1₁ and the second transparent conductive element 1₂ are set such that both of the transparent conductive layer 6₁ of the first transparent conductive element 1₁ and the transparent conductive layer 6₂ of the second transparent conductive element 1₂ are formed as input surface sides. However, the directions of the first transparent conductive element 1₁ and the second transparent conductive element 1₂ are not especially limited, and can be appropriately set in accordance with the design of the information input device 101.

As shown in FIG. 14A, in the region A₁, the transparent conductive layer 6₁ is not formed on the wave surface Sw of the first transparent conductive element 1₁. In contrast, it is preferable that the transparent conductive layer 6₂ should be formed on the wave surface Sw of the second transparent conductive element 1₂. Further, as shown in FIG. 14B, in the region A₂, the transparent conductive layer 6₁ is formed on the wave surface Sw of the first transparent conductive element 1₁. In contrast, it is preferable that the transparent conductive layer 6₂ should not be formed on the wave surface Sw of the second transparent conductive element 1₂.

As the first transparent conductive element 1₁ and the second transparent conductive element 1₂, one of the transparent conductive elements 1 according to the first to third embodiments may be used. That is, an optical layer 2₁, a base substance 3₁, structures 4₁, a basal layer 5₁, and the transparent conductive layer 6₁ of the first transparent conductive element 1₁ are respectively the same as the optical layer 2, the base substance 3, the structures 4, the basal layer 5, and the transparent conductive layer 6 of one element according to the first to third embodiments. Further, an optical layer 2₂, a base substance 3₂, structures 4₂, a basal layer 5₂, and the transparent conductive layer 6₂ of the second transparent conductive element 1₂ are respectively the same as the optical layer 2, the base substance 3, the structures 4, the basal layer 5, and the transparent conductive layer 6 of one element according to the first to third embodiments.

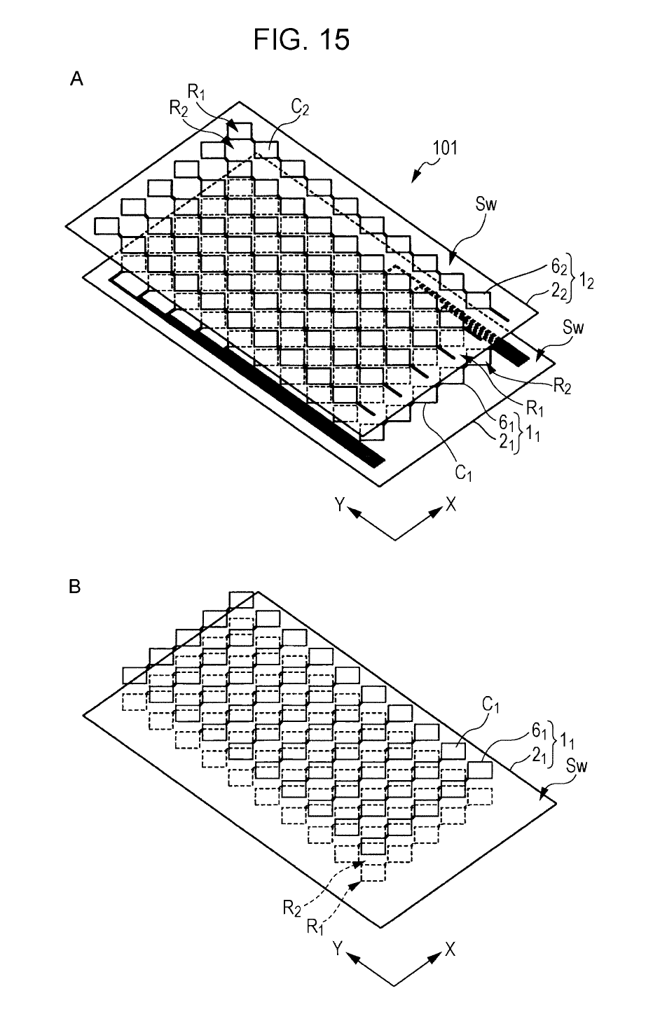

FIG. 15A is an exploded perspective view illustrating the example of the configuration of the information input device according to the fifth embodiment of the present invention. The information input device 101 is a projection capacitive touch panel with an ITO grid system. The transparent conductive layer 6₁ of the first transparent conductive element 1₁ is, for example, X electrodes (the first electrodes) with a prescribed pattern. The transparent conductive layer 6₂ of the second transparent conductive element 1₂ is, for example, Y electrodes (the second electrodes) with a prescribed pattern. The X electrode and the Y electrode are, for example, orthogonal to each other.

FIG. 15B is an exploded perspective view illustrating a configuration of a first transparent conductive element which is provided in the information input device according to the fifth embodiment of the present invention. In addition, since the second transparent conductive element 1₂ is the same as the first transparent conductive element 1₁ except the direction of forming the Y electrode made from the transparent conductive layer 6₂, the exploded perspective view is omitted.

In the region R₁ of the wave surface Sw of the optical layer 2₁, the plurality of X electrodes made from the transparent conductive layer 6₁ are arranged. In the region R₂ of the wave surface Sw of the optical layer 2₂, the plurality of Y electrodes made from the transparent conductive layer 6₁ are arranged. The X electrodes extending in the X-axis direction are formed by repeatedly connecting unit shapes C₁ in the X-axis direction. The Y electrodes extending in the Y-axis direction are connected by repeatedly connecting unit shapes C₂ in the Y-axis direction. Examples of the unit shape C₁ and the unit shape C₂ include an argyle shape (a diamond shape), a triangular shape, a tetragonal shape, and the like, but the shape is not limited to the examples.

In the state where the first transparent conductive element 1₁ and the second transparent conductive element 1₂ overlap each other, the first region R₁ of the first transparent conductive element 1₁ and the second region R₂ of the second transparent conductive element 1₂ overlap each other, and the second region R₂ of the first transparent conductive element 1₁ and the first region R₁ of the second transparent conductive element 1₂ overlap each other. Accordingly, as the information input device 101 is viewed from the input surface side, the unit shapes C₁ and the unit shapes C₂ do not overlap, and are arranged throughout the entire surface of one principal surface, and thus the device seems to be fully filled.

### 6. Sixth Embodiment

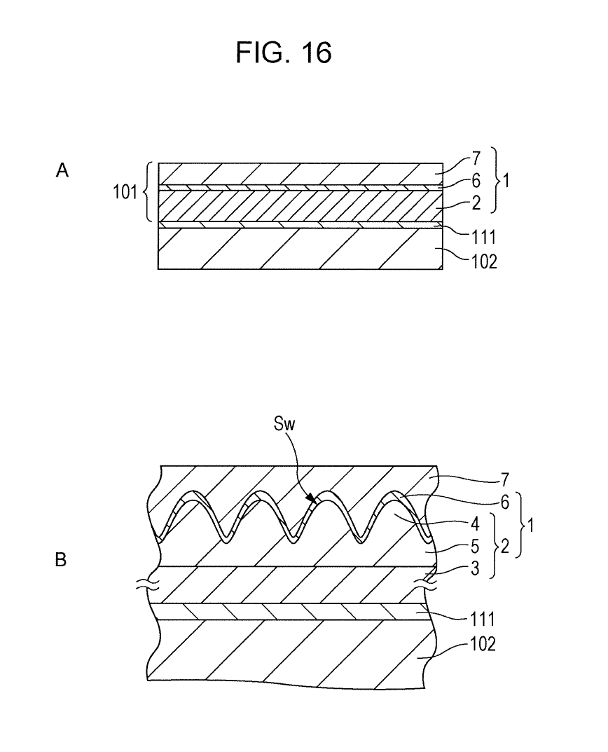

FIG. 16A is a sectional view illustrating an example of a configuration of an information input device according to a sixth embodiment of the present invention. FIG. 16B is an enlarged sectional view illustrating a part of the information input device shown in FIG. 16A in an enlarged manner.

The information input device 101 is a so-called surface capacitive touch panel, and has the transparent conductive element 1. As the transparent conductive element 1, the transparent conductive element 1 according to the fourth embodiment is used, and the optical layer (second optical layer) 7 is provided on the transparent conductive layer 6.

Except the above-mentioned difference, the sixth embodiment is the same as the fifth embodiment.

### 7. Seventh Embodiment

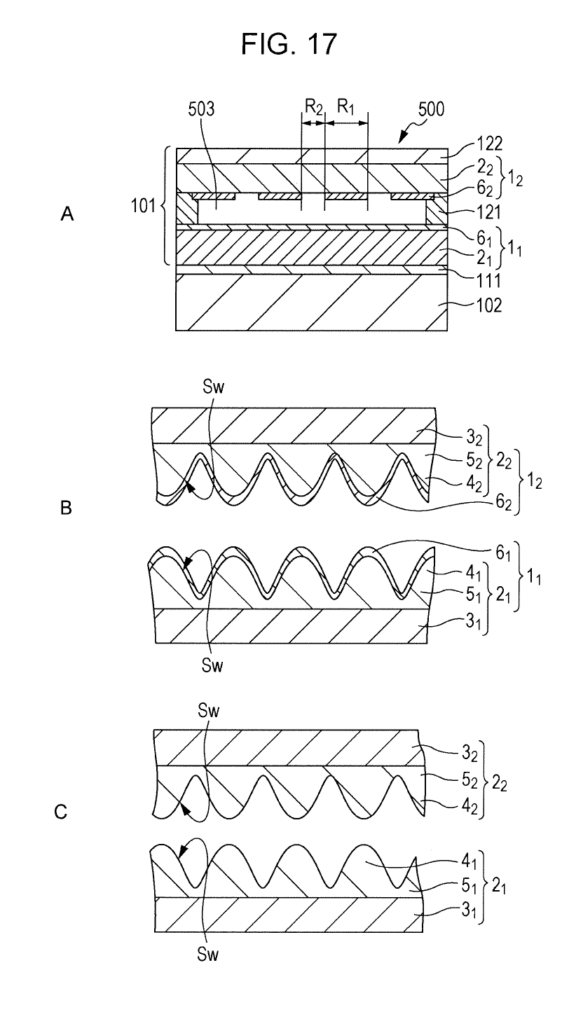

FIG. 17A is a sectional view illustrating an example of a configuration of an information input device according to a seventh embodiment of the present invention. FIG. 17B is a sectional view illustrating a region facing the wave surface, on which the transparent conductive layer is formed, in an enlarged manner. FIG. 17C is a sectional view illustrating a region facing the wave surface on which the transparent conductive layer is not formed and which is exposed, in an enlarged manner.

As shown in FIG. 17A, the information input device 101 is a so-called matrix film-to-film touch panel, and includes the first transparent conductive element 1₁, the second transparent conductive element 1₂, and the paste 121. The first transparent conductive element 1 and the second transparent conductive element 1₂ are arranged to be opposed to other, where that the transparent conductive layer 6₁ and the transparent conductive layer 6₂ of the respective elements are separated from each other by a predetermined space so as to be opposed to other. The paste layer 121 is disposed between the circumferential portions of the first transparent conductive element 1₁ and the second transparent conductive element 1₂, the circumferential portions of the opposed surfaces of the first transparent conductive element 1₁ and the second transparent conductive element 1₂ are attached through the paste layer 121. As the paste layer 121, for example, an adhesive paste, an adhesive tape, and the like are used.

The principal surface on the second transparent conductive element 1₂ side between the both principal surfaces of the information input device 101 is a touch surface (an information input surface) for inputting information. It is preferable that a hard coat layer 122 should be further provided on the touch surface. The reason is that it is possible to increase abrasion resistance of the touch surface of the touch panel 50.

As shown in FIGS. 17B and 17C, the wave surfaces Sw of the first transparent conductive element 1₁ and the second transparent conductive element 1₂ are arranged to be opposed to other at a predetermined distance. In the information input device 101 as a matrix film-to-film touch panel, the transparent conductive layer 6₁ and the transparent conductive layer 6₂ with the prescribed patterns are respectively formed on the wave surfaces Sw of the first transparent conductive element 1₁ and the second transparent conductive element 1₂. Hence, in the information input device 101, the following regions are present: a region (FIG. 17B) where the wave surface Sw on which the transparent conductive layer 6₁ is formed is opposed to the wave surface Sw on which the transparent conductive layer 6₂ is formed; a region (FIG. 17C) where the wave surface Sw on which the transparent conductive layer 6₁ is not formed and which is exposed is opposed to the wave surface Sw on which the transparent conductive layer 6₂ is not formed and which is exposed; and a region (not shown in the drawing) where the wave surface Sw on which the transparent conductive layer 6₁ or the transparent conductive layer 6₂ is formed is opposed to the wave surface Sw on which the transparent conductive layer 6₁ or the transparent conductive layer 6₂ is not formed and which is exposed.

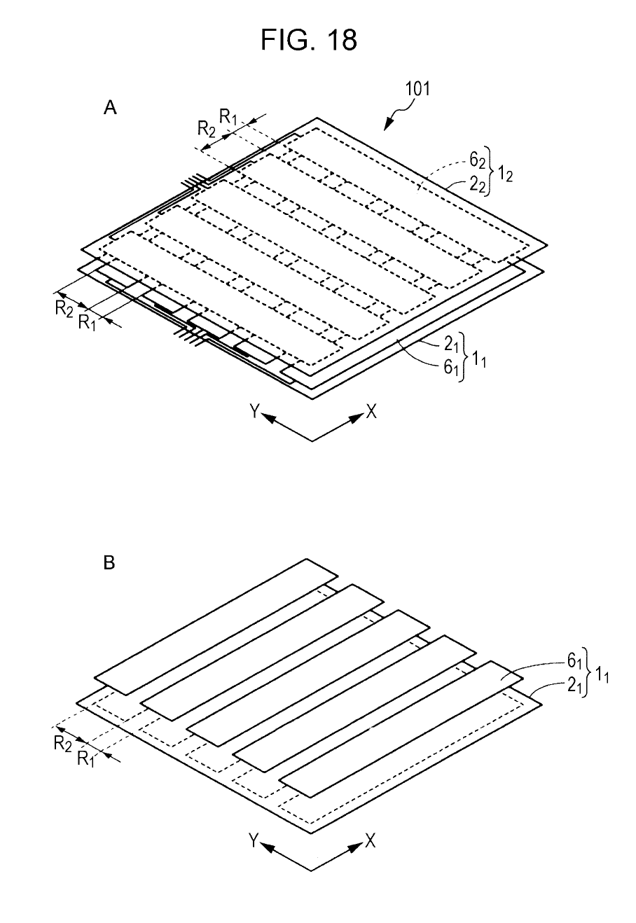

FIG. 18A is an exploded perspective view illustrating an example of the configuration of the information input device according to the seventh embodiment of the present invention. FIG. 18B is an exploded perspective view illustrating a configuration of a transparent conductive element which is provided in the information input device according to the seventh embodiment of the present invention. The transparent conductive layer 6₁ of the first transparent conductive element 1₁ is, for example, X electrodes (the first electrodes) having a stripe shape. The transparent conductive layer 6₂ of the second transparent conductive element 1₂ is, for example, Y electrodes (the second electrodes) having a stripe shape. The first transparent conductive element 1₁ and the second transparent conductive element 1₂ are arranged to be opposed to each other such that the X electrodes and the Y electrodes are opposed to each other and are orthogonal to each other.

Except the above-mentioned difference, the seventh embodiment is the same as the fifth embodiment.

### 8. Eighth Embodiment

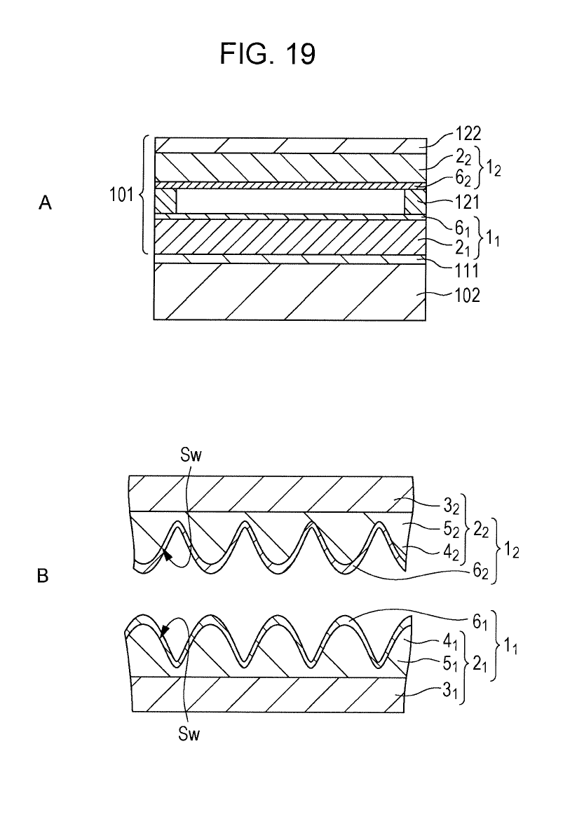

FIG. 19A is a sectional view illustrating an example of a configuration of an information input device according to an eighth embodiment of the present invention. FIG. 19B is an enlarged sectional view illustrating a part of the information input device shown in FIG. 19A in an enlarged manner.

As shown in FIG. 19A, the information input device 101 according to the eighth embodiment is different from the information input device 101 according to the seventh embodiment in that the transparent conductive element 1 according to the fourth embodiment is used as the first transparent conductive element 1₁ and the second transparent conductive element 1₂.

As shown in FIG. 19B, the wave surfaces Sw of the first transparent conductive element 1₁ and the second transparent conductive element 1₂ are arranged to be opposed to each other, and the transparent conductive layer 6₁ and the transparent conductive layer 6₂ are respectively formed on the wave surfaces which are arranged to be opposed to each other.

Except the above-mentioned difference, the eighth embodiment is the same as the seventh embodiment.

### 9. Ninth Embodiment

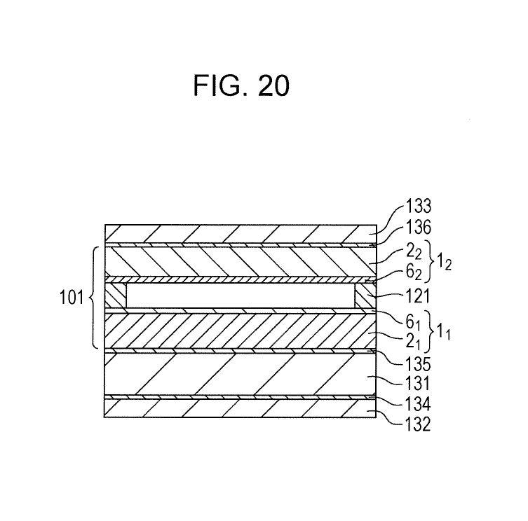

FIG. 20 is a sectional view illustrating an example of a configuration of a liquid crystal display apparatus according to a ninth embodiment of the present invention. As shown in FIG. 20, the liquid crystal display apparatus according to the ninth embodiment includes: a liquid crystal panel (liquid crystal layer) 131 that has a first principal surface and second principal surface; a first polarizer 132 that is formed on a first principal surface; a second polarizer 133 that is formed on a second principal surface; and the information input device 101 that is disposed between the liquid crystal panel 131 and the second polarizer 133. The information input device 101 is a built-in liquid crystal display touch panel (a so-called inner touch panel). By omitting the optical layer 2₂, the plurality of structures 4 may be directly formed on the surface of the second polarizer 133. When a protective layer such as a TAC (triacetyl cellulose) film is provided on the surface of the second polarizer 133, it is preferable that the plurality of structures 4 should be directly formed on the protective layer. As described above, the plurality of structures 4 is formed on the second polarizer 133, and the transparent conductive layer 6₂ is formed on the structures 4, whereby it is possible to further decrease the thickness of the liquid crystal display apparatus.

(Liquid Crystal Panel)

As the liquid crystal panel 131, for example, the following display modes may be used: a twisted nematic (TN) mode, a super twisted nematic (STN) mode, a vertically aligned (VA) mode, an in-plane switching (IPS) mode, an optically compensated birefringence (OCB) mode, a ferroelectric liquid crystal (FLC) mode, a polymer dispersed liquid crystal (PDLL) mode, a phase change guest host (PCGH) mode, and the like.

(Polarizer)

The first polarizer 132 and the second polarizer 133 are respectively attached onto the first principal surface and the second principal surface of the liquid crystal panel 131 through the paste layer 134 and the paste layer 136 such that the transmission axes of the polarizers are orthogonal to each other. The first polarizer 132 and second polarizer 133 pass one polarized light component orthogonal thereto among the incident rays, and absorb the other polarized light component so as to block the component. As the first polarizer 132 and the second polarizer 133, for example, a polarizer, in which iodine complexes or dichroic dyes are arranged in one-axis direction on a polyvinylalcohol (PVA) based film, may be used. It is preferable that protective layers such as triacetyl cellulose (TAC) films should be provided on both surfaces of the first polarizer 132 and the second polarizer 133.

(Touch Panel)

Any one of the information input devices 101 according to the fifth to eighth embodiments may be used.

In the ninth embodiment, the liquid crystal panel 135 and the information input device 101 are configured to share the second polarizer 133, and thus it is possible to improve optical characteristics.

### 10. Tenth Embodiment

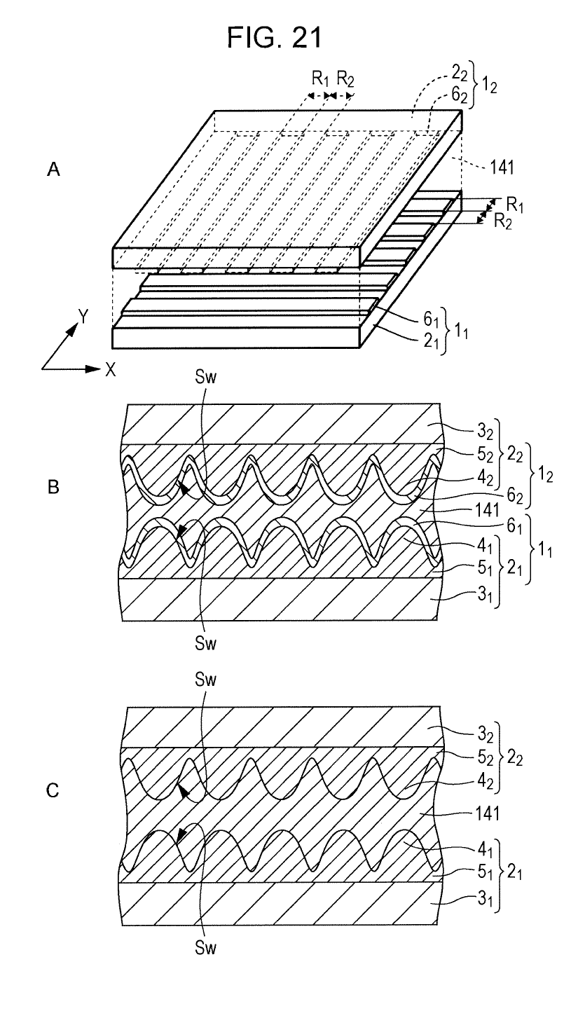

FIG. 21A is a perspective view illustrating an example of a configuration of an information display apparatus according to a tenth embodiment of the present invention. FIG. 21B is a sectional view illustrating a region facing the wave surface, on which the transparent conductive layer is formed, in an enlarged manner. FIG. 21C is a sectional view illustrating a region facing the wave surface on which the transparent conductive layer is not formed and which is exposed, in an enlarged manner.

As shown in FIG. 21A, the information display apparatus is a liquid crystal display apparatus of a passive matrix driving mode (which is also referred to as a simple matrix driving mode), and includes the first transparent conductive element 1₁, the second transparent conductive element 1₂, and a liquid crystal layer 141. The first transparent conductive element 1₁ and the second transparent conductive element 1₂ are arranged to be opposed to each other at a predetermined distance such that the transparent conductive layer 6₁ and the transparent conductive layer 6₂ of the respective elements are opposed to each other. The liquid crystal layer 141 is provided between the first transparent conductive element 1₁ and the second transparent conductive element 1₂ which are arranged to be separated from each other by a predetermined distance. As the first transparent conductive element 1₁ and the second transparent conductive element 1₂, one of the transparent conductive elements 1 according to the first to third embodiments may be used. That is, an optical layer 2₁, a base substance 3₁, structures 4₁, a basal layer 5₁, and the transparent conductive layer 6₁ of the first transparent conductive element 1₁ are respectively the same as the optical layer 2, the base substance 3, the structures 4, the basal layer 5, and the transparent conductive layer 6 of one element according to the first to third embodiments. Further, an optical layer 2₂, a base substance 3₂, structures 4₂, a basal layer 5₂, and the transparent conductive layer 6₂ of the second transparent conductive element 1₂ are respectively the same as the optical layer 2, the base substance 3, the structures 4, the basal layer 5, and the transparent conductive layer 6 of one element according to the first to third embodiments. Here, the description was given of the example in which the present invention is applied to a liquid crystal display apparatus of the passive matrix driving mode. However, the information display apparatus is not limited to the example, and the present invention may be applicable thereto if the information display apparatus has a prescribed electrode pattern of a passive matrix driving mode or the like. For example, the present invention is applicable to an EL display apparatus of the passive matrix driving mode and the like.

As shown in FIGS. 21B and 21C, the wave surfaces Sw of the first transparent conductive element 1₁ and the second transparent conductive element 1₂ are arranged to be opposed to other at a predetermined distance. In the liquid crystal display apparatus of the passive matrix driving mode, the transparent conductive layer 6₁ and the transparent conductive layer 6₂ with the prescribed patterns are respectively formed on the wave surfaces Sw of the first transparent conductive element 1₁ and the second transparent conductive element 1₂. Hence, there are the following regions: a region (FIG. 21B) where the wave surface Sw on which the transparent conductive layer 6₁ is formed is opposed to the wave surface Sw on which the transparent conductive layer 6₂ is formed; a region (FIG. 21C) where the wave surface Sw on which the transparent conductive layer 6₁ is not formed and which is exposed is opposed to the wave surface Sw on which the transparent conductive layer 6₂ is not formed and which is exposed; and a region (not shown in the drawing) where the wave surface Sw on which the transparent conductive layer 6₁ or the transparent conductive layer 6₂ is formed is opposed to the wave surface Sw on which the transparent conductive layer 6₁ or the transparent conductive layer 6₂ is not formed and which is exposed.

The transparent conductive layer 6₁ of the first transparent conductive element 1₁ is, for example, X electrodes (the first electrodes) having a stripe shape. The transparent conductive layer 6₂ of the second transparent conductive element 1₂ is, for example, Y electrodes (the second electrodes) having a stripe shape. The first transparent conductive element 1₁ and the second transparent conductive element 1₂ are arranged to be opposed to each other such that the X electrodes and the Y electrodes are opposed to each other and are orthogonal to each other.

### 11. Eleventh Embodiment

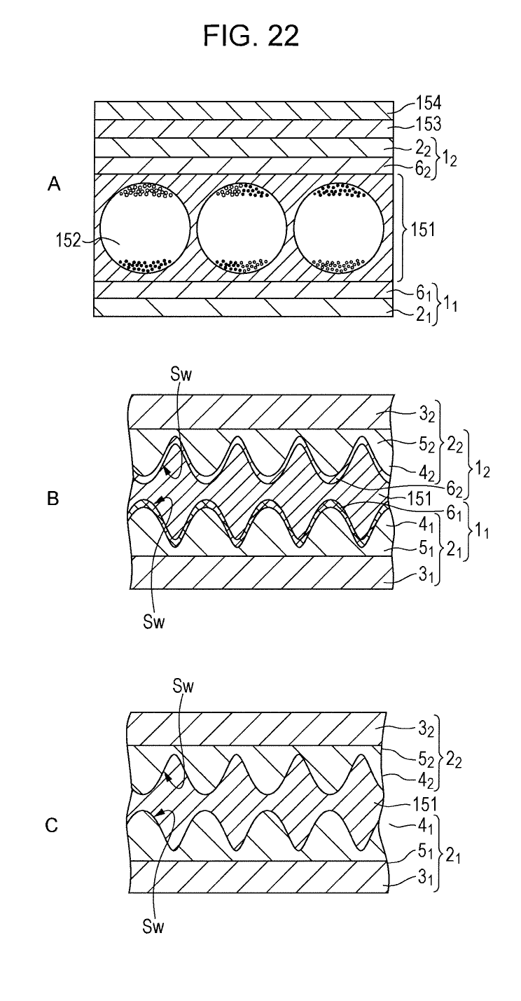

FIG. 22A is a sectional view illustrating an example of a configuration of an information display apparatus according to an eleventh embodiment of the present invention. FIG. 22B is a sectional view illustrating a region facing the wave surface, on which the transparent conductive layer is formed, in an enlarged manner. FIG. 22C is a sectional view illustrating a region facing the wave surface on which the transparent conductive layer is not formed and which is exposed, in an enlarged manner.

As shown in FIG. 22A, the information display apparatus is a so-called micro capsule electrophoretic type electronic paper, and includes the first transparent conductive element 1₂, the second transparent conductive element 1₂, and a micro capsule layer (a medium layer) 151. The first transparent conductive element 1₁ and the second transparent conductive element 1₂ are arranged to be opposed to each other at a predetermined distance such that the transparent conductive layer 6₁ and the transparent conductive layer 6₂ of the respective elements are opposed to each other. The micro capsule layer 151 is provided between the first transparent conductive element 1₁ and the second transparent conductive element 1₂ which are arranged to be separated from each other by a predetermined distance.

Further, as necessary, the second transparent conductive element 1₂ may be attached to a supporting body 154 such as a glass through a paste layer 153 such as an adhesive. Here, the description was given of the example in which the present invention is applied to the micro capsule electrophoretic type electronic paper. However, the electronic paper is not limited to the example, and the present invention may be applicable thereto if the configuration is made such that the medium layer is provided between the conductive elements which are arranged to be opposed to each other. Here, the medium is defined to include not only liquid and solid but also gas such as air. Further, the medium may contain members such as capsules, pigments, and particles.

Examples of the electronic paper, to which the present invention is applicable, other than the micro capsule electrophoretic type include electronic papers of a twist ball type, a thermal rewritable type, a toner display type, an in-plane electrophoretic type, an electronic particle type, and the like. The micro capsule layer 151 includes multiple micro capsules 152. In the micro capsules, for example, transparent liquid (a dispersion medium), in which black particles and white particles are distributed, is encapsulated.

The transparent conductive layer 6₁ of the first transparent conductive element 1₁ and the transparent conductive layer 6₂ of the second transparent conductive element 1₂ are formed in prescribed electrode pattern shapes in accordance with the driving mode of the information display apparatus as an electronic paper. Examples of the driving mode include a simple matrix driving mode, an active matrix driving mode, a segment driving mode, and the like.

As shown in FIGS. 22B and 22C, the wave surfaces Sw of the first transparent conductive element 1₁ and the second transparent conductive element 1₂ are arranged to be opposed to other at a predetermined distance. In the electronic paper of the passive matrix driving mode, the transparent conductive layer 6₁ and the transparent conductive layer 6₂ with the prescribed patterns are respectively formed on the wave surfaces Sw of the first transparent conductive element 1₁ and the second transparent conductive element 1₂. Hence, there are the following regions: a region (FIG. 22B) where the wave surface Sw on which the transparent conductive layer 6₁ is formed is opposed to the wave surface Sw on which the transparent conductive layer 6₂ is formed; a region (FIG. 22C) where the wave surface Sw on which the transparent conductive layer 6₁ is not formed and which is exposed is opposed to the wave surface Sw on which the transparent conductive layer 6₂ is not formed and which is exposed; and a region (not shown in the drawing) where the wave surface Sw on which the transparent conductive layer 6₁ or the transparent conductive layer 6₂ is formed is opposed to the wave surface Sw on which the transparent conductive layer 6₁ or the transparent conductive layer 6₂ is not formed and which is exposed.

Except the above-mentioned difference, the eleventh embodiment is the same as the tenth embodiment.

### EXAMPLES

Hereinafter, the present invention will be described in detail through samples, but the present invention is not limited to only the samples.

(Average Height Hm, Average Array Pitch Pm, Aspect Ratio (Hm/Pm))

Hereinbelow, the average height Hm, the average array pitch Pm, and the aspect ratio (Hm/Pm) of the structures of the transparent conductive sheet or the like was obtained in the following manner.

First, by cutting the transparent conductive sheet so as to truncate the apexes of the structures, the section was photographed by the transmission electron microscope (TEM). Next, from the taken TEM picture, the array pitch P of the structures and the heights H of the structures were obtained. The measurement was repeated at 10 locations which were randomly selected from the transparent conductive sheet, and the measurement values are simply averaged (arithmetically averaged), whereby the average array pitch Pm and the average height Hm was obtained. Then, by using the average array pitch Pm and the average height Hm, the aspect ratio (Hm/Pm) was calculated.

In addition, the average height Hm, the average array pitch Pm, and the aspect ratio (Hm/Pm) of the structures respectively correspond to the average width Am of the oscillation of the wave surface, the average wavelength λm of the wave surface, and the ratio (Am/λm).

(Film Thickness of ITO Film)

Hereinbelow, the film thickness of the ITO film was obtained in the following manner.

First, by cutting the transparent conductive sheet so as to truncate the apexes of the structures, the section was photographed by the transmission electron microscope (TEM), and the film thickness of the ITO film at the apex of the structure is measured from the taken TEM picture.

(Average Angle of Inclined Surface of Structure)

Hereinbelow, the average angle of the inclined surface of the structure was obtained in the following manner.

First, by cutting the transparent conductive sheet so as to truncate the apexes of the structures, the section was photographed by the transmission electron microscope (TEM). Next, from the taken TEM picture, an average value (an average value of the inclined surface angles of the single structure) of the angles of the inclined surface from the bottom to the apex was obtained. The processing of calculating the average values was repeated at 10 locations which were randomly selected from the transparent conductive sheet, and the average values of the inclined surface angles of the 10 structures were simply averaged (arithmetically averaged), whereby the average angle of the inclined surface of the structure was obtained.

The samples 1-1 to 10-5 will be described in order to the following items.

1. Area Ratio of Planar Portion (Samples 1-1 to 1-3)

2. Color Hue (Samples 2-1 to 2-3)

3. Film Thickness Ratio of Transparent Conductive Layer (Samples 3-1 to 3-3)

4. Aspect Ratio (Samples 4-1 to 4-4)

5. Electric Reliability (Samples 5-1 to 5-6)

6. Reflectance Difference ΔR (Samples 6-1 to 6-4)

7. Shape of Structure (Samples 7-1 to 7-3)

8. Pattern Distortion (Samples 8-1 and 8-2)

9. Etching Resistance (Samples 9-1 to 10-5)

### <1. Area Ratio of Planar Portion>

Regarding samples 1-1 to 1-3, through an optical simulation based on RCWA (Rigorous Coupled Wave Analysis), a study was made on the relationship between the area ratio of planar portion and the reflectance.

(Sample 1-1)

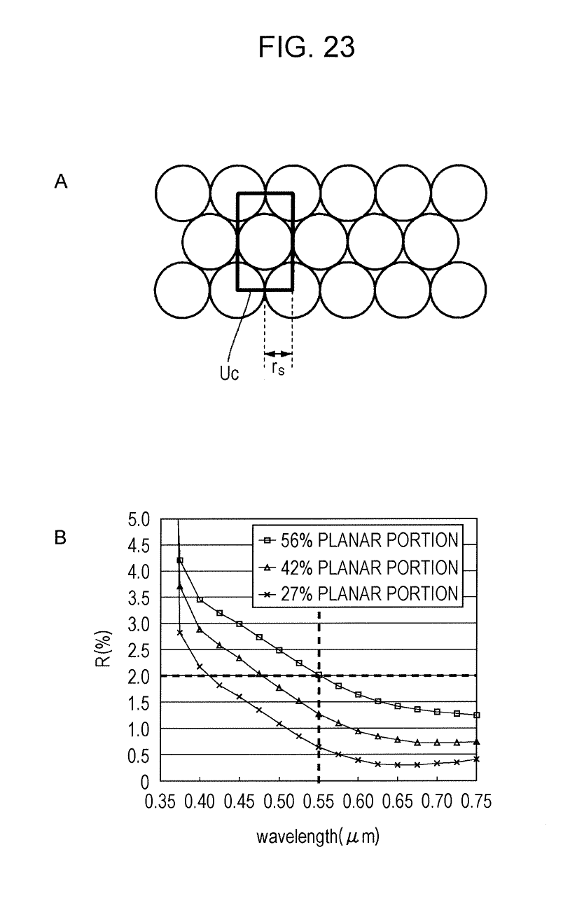

Through the optical simulation, the reflectance spectra of the transparent conductive elements were obtained. The graph of the results is shown in FIG. 23B.

Hereinbelow, the conditions of the optical simulation will be described.

(Configuration of Transparent Conductive Element)

The transparent conductive element was formed of the following laminated structures.

(Incidence side) base substance/structures/transparent conductive layer/optical layer (exit side)

FIG. 23A is a top plan view illustrating the plurality of structures which are arranged on the base substance surface. In FIG. 23A, the circular shape represents the structure bottom face, Uc represents the unit cell, and rₛ represents the radius of the structure bottom face. As shown in FIG. 23A, the plurality of structures are arranged on the base substance surface.

(Base Substance)

Refractive index n: 1.52

(Structure)

Array of structures: hexagonal lattice

Shape of structure: bell form

Bottom face of structure: circular shape

Array pitch (wavelength λ) P: 250 nm

Structure height (amplitude A) H: 150 nm

Aspect ratio (H/P): 0.6

Area S of unit cell Uc (lattice): 2×2√3

Radius rₛ of bottom face of structure: 0.9

Area S (structure) of bottom face of structure: 2×πrₛ²=2×π×0.9²

Area ratio Rₛ of planar portion: [(S(lattice)−S(structure))/S(lattice)]×100=26.54%

(Transparent Conductive Layer)

Refractive index n of transparent conductive layer: 2.0

Thickness t of transparent conductive layer: 60 to 75 nm

Thickness D1 of transparent conductive layer at apex of structure: 75 nm

Thickness D3 of transparent conductive layer between structures: 60 nm

Film thickness ratio D3/D1: 0.8

(Optical Layer)

Refractive index n: 1.52

(Incident Light)

Polarization: no polarization

Incident angle: 5 degrees (with respect to normal line of transparent conductive element)

(Sample 1-2)

Similarly to sample 1-1 except change of the following conditions, through the optical simulation, the reflectance spectra of the transparent conductive elements were obtained. The graph of the results is shown in FIG. 23B.

(Structure)

Radius r₃ of bottom face of structure: 0.8

Area S(structure) of bottom face of structure: 2×πrₛ²=2×π×0.8²

Area ratio of planar portion: [(S(lattice)−S(structure))/S(lattice)]×100=41.96%

(Sample 1-3)

Similarly to sample 1-1 except change of the following conditions, through the optical simulation, the reflectance spectra of the transparent conductive elements were obtained. The graph of the results is shown in FIG. 23B.

(Structure)

Radius r₃ of bottom face of structure: 0.7

Area S (structure) of bottom face of structure: 2×πrₛ²=2×π×0.7²

Area ratio of planar portion: [(S(lattice)−S(structure))/S(lattice)]×100=55.56%

From FIG. 23B, the following respects can be seen.

By setting the area ratio of the planar portion on the surface of the transparent conductive element to 50% or less, it is possible to set the luminous reflectance (the reflectance at the wavelength of 550 nm) to 2% or less.

By setting the luminous reflectance to 2% or less, it is possible to improve the visibility.

In addition, when the radius rₛ of the bottom face of the structure, the area S (structure) of the bottom face of the structure, and the area ratio Rₛ of the planar portion are set as follows, as compared with sample 1-1, it is possible to further reduce the reflectance.

Radius rₛ of bottom face of structure: 1.0

Area S (structure) of bottom face of structure: 2×πrₛ²=2×π×1.0²

Area ratio Rₛ of planar portion: [(S(lattice)−S(structure))/S(lattice)]×100=9.31%

### <2. Color Hue>

Regarding samples 2-1 to 2-3, by actually producing the transparent conductive sheet, a study was made on the color hue.

(Sample 2-1)

First, a glass roll master mold, of which the outer diameter is 126 mm, was provided, and a resist layer was formed on the surface of the glass roll master mold in the following manner. That is, a photoresist was diluted to 1/10 with a thinner, and the diluted resist was applied on the columnar surface of the glass roll master mold in a dipping method so as to have a thickness of about 70 nm, whereby the resist layer was formed. Next, the glass roll master mold as a recording medium was transported to the apparatus for exposing the roll mater disk shown in FIG. 7, and the resist layer was exposed. A latent image, which is continuously formed in a shape of one spiral and forms a hexagonal lattice pattern in the space of three columns of adjacent tracks, is patterned on the resist layer.

Specifically, the region as a target of formation of the exposure pattern with the hexagonal lattice shape was irradiated with laser light, which had a power of 0.50 mW/m, for performing exposure up to the glass roll master mold surface, whereby the exposure pattern with the hexagonal lattice shape was formed. In addition, the thickness of the resist layer in the column direction of the track line was about 60 nm, and the resist thickness in the track extension direction was about 50 nm.

Subsequently, by performing the development treatment on the resist layer on the glass roll master mold, the resist layer corresponding to the exposed portion was dissolved, whereby development was performed. Specifically, the undeveloped glass roll master mold was placed on a turntable of a developing machine which is not shown, and the developing liquid was dripped onto the surface of the glass roll master mold while the mold was rotated together with the turntable, whereby the resist layer on the surface was developed. Thereby, it was possible to obtain the resist glass master mold of which the resist layer was open in the hexagonal lattice pattern.

Next, by using a roll etching apparatus, plasma etching was performed in CHF₃ gas atmosphere. Thereby, the etching progressed only in a part of the hexagonal lattice pattern exposed from the resist layer on the surface of the glass roll master mold, the other region was not etched since the resist layer serves as a mask, and concave portions with an elliptical cone shape were formed on the glass roll master mold. At this time, the amount (depth) of etching was adjusted by the etching time. Finally, by completely removing the resist layer through O₂ ashing, it was possible to obtain a moth-eye glass roll master with a hexagonal lattice pattern having a concave shape. The depth of the concave shape in the column direction was larger than the depth of the concave portion in the track extension direction.

Subsequently, by using the moth-eye glass roll master, the plurality of structures were formed on a PET sheet with a thickness of 125 μm through UV imprinting. Specifically, the PET (polyethylene terephthalate) sheet coated with the ultraviolet curable resin was brought into close contact with the moth-eye glass roll master, and then was exfoliated while being irradiated with ultraviolet rays. Thereby, it was possible to obtain an optical sheet in which the following plural structures are arranged on one principal surface.

Array of structures: hexagonal lattice

Shape of structure: bell form

Average array pitch (wavelength λ) Pm of structures: 250 nm

Average height (amplitude A) Hm of structures: 125 nm

Aspect ratio (Hm/Pm) of structure: 0.5

Next, by forming the ITO layer on the PET sheet surface on which the plurality of structures were formed through a sputtering method, the transparent conductive sheet was produced.

Hereinbelow, film formation conditions of the ITO layer will be described.

Gas type: mixed gas between Ar gas and O₂ gas

Mixing ratio (volume ratio) of mixed gas: Ar:O₂=200:10

Film thickness of ITO layer: 75 nm

Here, the film thickness of the ITO layer is the film thickness at the apex of the structure.

Next, the transparent conductive sheet was attached onto the glass substrate of which the refractive index is 1.5 through an adhesive sheet such that the surface thereof on the ITO layer side was close to the surface of the glass substrate.

In the above-mentioned manner, a desirable transparent conductive sheet was produced.

(Sample 2-2)

Similarly to sample 2-1 except that the following plural structures were arranged on one principal surface of the PET sheet, the optical sheet was produced.

Array of structures: hexagonal lattice

Shape of structure: bell form

Average array pitch Pm of structures: 250 nm

Average structure height Hm of structures: 150 nm

Aspect ratio (Hm/Pm): 0.6

Next, by forming the ITO layer on the PET sheet surface on which the plurality of structures were formed through a sputtering method, the transparent conductive sheet was produced.

Hereinbelow, film formation conditions of the ITO layer will be described.

Gas type: Mixed gas between Ar gas and O₂ gas

Mixing ratio (volume ratio) of mixed gas: Ar:O₂=200:10

Film thickness of ITO layer: 100 nm

Here, the film thickness of the ITO layer is the film thickness at the apex of the structure.

Next, the transparent conductive sheet was attached onto the glass substrate of which the refractive index is 1.5 through an adhesive sheet such that the surface thereof on the ITO layer side was close to the surface of the glass substrate.

In the above-mentioned manner, a desirable transparent conductive sheet was produced.

(Sample 2-3)

First, similarly to sample 2-1 except that the formation of the ITO layer was omitted, the optical sheet was produced.

Next, the optical sheet was attached onto the glass substrate of which the refractive index is 1.5 through an adhesive sheet such that the surface thereof, on which the plurality of structures were formed, was close to the surface of the glass substrate.

In the above-mentioned manner, a desirable transparent conductive sheet was produced.

(Transmitted Hue)

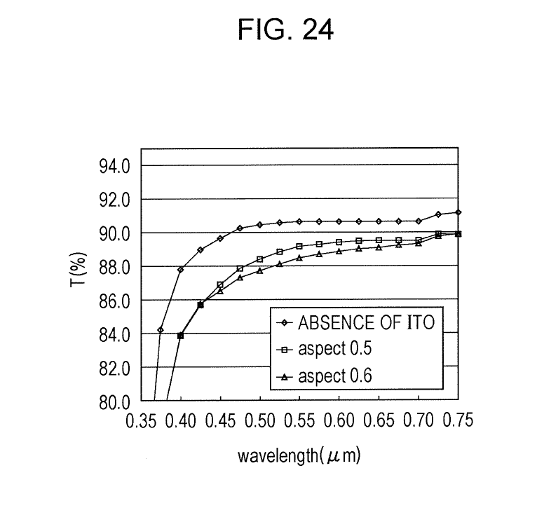

By using the transparent conductive sheet and the optical sheet which were manufactured as described above as measurement samples, transmission spectra in a wavelength band (350 nm to 800 nm) near the visible wavelength band were measured by a spectrophotometer, and transmitted hues a* and b* are calculated from the transmission spectra. The measurement results of the transmission spectra are shown in FIG. 24. The calculation results of the transmitted hues a* and b* are shown in Table 1.

Table 1 shows the calculation results of the transmitted hues of samples 2-1 to 2-3.

TABLE 1

| | SAMPLE 2-1 | SAMPLE 2-2 |
|---|---|---|
| ASPECT | 0.5 | 0.6 |
| a*(TRANSMISSION) | −0.35 | −0.12 |
| b*(TRANSMISSION) | 1.48 | 1.29 |

From Table 1, the following respects can be seen.

In the transparent conductive sheets of samples 2-1 and 2-2, a* and b* are smaller than 3, and thus it can be seen that the sheets are colorless and transparent and have excellent characteristics.

### <3. Film Thickness Ratio of Transparent Conductive Layer>

Regarding samples 3-1 to 3-3, through the optical simulation based on RCWA, a study was made on the relationship between the film thickness ratio (D3/D1) and the reflectance of the transparent conductive layer.

(Sample 3-1)

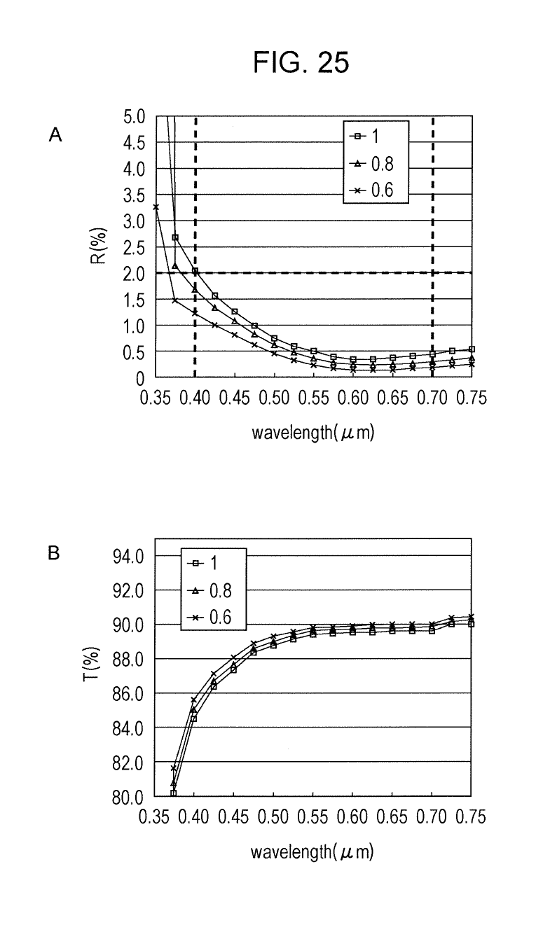

Through the optical simulation, the reflectance spectra of the transparent conductive elements were obtained, and from the reflectance spectra, the reflected hues a* and b* and the reflection Y values were obtained. The graph of the results is shown in FIG. 25A and Table 2.

Likewise, through the optical simulation, the transmission spectra of the transparent conductive elements were obtained, and from the transmission spectra, the transmitted hues a* and b* were obtained. The graph of the results is shown in FIG. 25B and Table 3.

Hereinbelow, the conditions of the optical simulation will be described.

(Configuration of Transparent Conductive Element)

The transparent conductive element was formed of the following laminated structures.

(Incidence side) base substance/structures/transparent conductive layer/optical layer (exit side)

(Base Substance)

Refractive index n: 1.52

(Structure)

Array of structures: hexagonal lattice

Shape of structure: bell form

Bottom face of structure: circular shape

Array pitch (wavelength λ) P: 250 nm

Structure height (amplitude A) H: 150 nm

Aspect ratio (H/P): 0.6

Area S of unit cell Uc (lattice): 2×2√3

Area ratio Rₛ of planar portion: [(S(lattice)−S(structure))/S(lattice)]×100=42%

(Transparent Conductive Layer)

Refractive index n of transparent conductive layer: 2.0

Thickness t of transparent conductive layer: 50 nm

Thickness D1 of transparent conductive layer at apex of structure: 50 nm

Thickness D3 of transparent conductive layer between structures: 50 nm

Film thickness ratio D3/D1: 1

(Optical Layer)

Refractive index n: 1.52

(Incident Light)

Polarization: no polarization

Incident angle: 5 degrees (with respect to normal line of transparent conductive element)

(Sample 3-2)

Similarly to sample 3-1 except change of the following conditions, the optical simulation was performed, and the reflectance spectra were obtained. Then, from the reflectance spectra, the reflected hues a* and b* and the reflection Y values were obtained. The graph of the results is shown in FIG. 25A and Table 2.

Likewise, through the optical simulation, the transmission spectra of the transparent conductive elements were obtained, and from the transmission spectra, the transmitted hues a* and b* were obtained. The graph of the results is shown in FIG. 25B and Table 3.

(Transparent Conductive Layer)

Thickness t of transparent conductive layer: 40 to 50 nm

Thickness D1 of transparent conductive layer at apex of structure: 50 nm

Thickness D3 of transparent conductive layer between structures: 40 nm

Film thickness ratio D3/D1: 0.8

(Sample 3-3)

Similarly to sample 3-1 except change of the following conditions, the optical simulation was performed, and the reflectance spectra were obtained. Then, from the reflectance spectra, the reflected hues a* and b* and the reflection Y values were obtained. The graph of the results is shown in FIG. 25A and Table 2.

Likewise, through the optical simulation, the transmission spectra of the transparent conductive elements were obtained, and from the transmission spectra, the transmitted hues a* and b* were obtained. The graph of the results is shown in FIG. 25B and Table 3.

(Transparent Conductive Layer)

Thickness t of transparent conductive layer: 30 nm to 50 nm

Thickness D1 of transparent conductive layer at apex of structure: 50 nm

Thickness D3 of transparent conductive layer between structures: 30 nm

Film thickness ratio D3/D1: 0.6

TABLE 2

| | SAMPLE | SAMPLE | SAMPLE |
|---|---|---|---|
| | 3-1 | 3-2 | 3-3 |
| THICKNESS RATIO D3/D1 | 1 | 0.8 | 0.6 |
| a*(REFLECTION) | 2.32 | 1.8 | 1.26 |
| b*(REFLECTION) | −10.7 | −10 | −7.9 |
| Y | 0.46 | 0.36 | 0.24 |

TABLE 3

| | SAMPLE | SAMPLE | SAMPLE |
|---|---|---|---|
| | 3-1 | 3-2 | 3-3 |
| THICKNESS RATIO D3/D1 | 1 | 0.8 | 0.6 |
| a*(TRANSMISSION) | −0.36 | −0.34 | −0.31 |
| b*(TRANSMISSION) | 1.31 | 1.23 | 1.11 |

From FIG. 25A, the following respects can be seen.

By setting the film thickness ratio D3/D1 to less than 1, it is possible to improve the reflection characteristics. Specifically, the film thickness ratio D3/D1 is preferably 0.8 or less, and more preferably 0.6 or less.

### <4. Aspect Ratio>

Regarding sample 4-1 to 4-4, through the optical simulation based on RCWA, a study was made on the relationship between the aspect ratio and the reflectance of the structures.

(Sample 4-1)

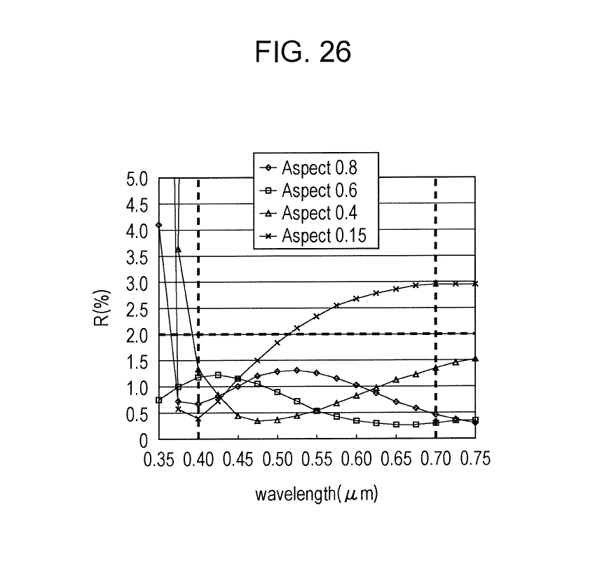

Through the optical simulation, the reflectance spectra of the transparent conductive elements were obtained, and from the reflectance spectra, the reflected hues a* and b* and the reflection Y values were obtained. The results are shown in FIG. 26 and Table 4. The results are shown in FIG. 26 and Table 4.

Hereinbelow, the conditions of the optical simulation will be described.

(Configuration of Transparent Conductive Element)

The transparent conductive element is formed of the following laminated structures.

(incidence side) base substance/structures/transparent conductive layer/optical layer (exit side)

(Base Substance)

Refractive index n: 1.52

(Structure)

Array of structures: hexagonal lattice

Shape of structure: bell form

Bottom face of structure: circular shape

Array pitch (wavelength λ) P: 250 nm

Structure height (amplitude A) H: 200 nm

Aspect ratio (H/P): 0.8

Area S of unit cell Uc (lattice): 2×2√3

Area ratio Rₛ of planar portion: [(S(lattice)−S(structure))/S(lattice)]×100=42%

(Transparent Conductive Layer)

Refractive index n of transparent conductive layer: 2.0

Thickness t of transparent conductive layer: 60 to 75 nm

Thickness D1 of transparent conductive layer at apex of structure: 75 nm

Thickness D3 of transparent conductive layer between structures: 60 nm

Film thickness ratio D3/D1: 0.8

(Optical Layer)

Refractive index n: 1.52

(Incident Light)

Polarization: no polarization

Incident angle: 5 degrees (with respect to normal line of transparent conductive element)

(Sample 4-2)

Similarly to sample 4-1 except change of the following conditions, the optical simulation was performed, and the reflectance spectra were obtained. Then, from the reflectance spectra, the reflected hues a* and b* and the reflection Y values were obtained. The graph of the results is shown in FIG. 26 and Table 4.

(Structure)

Array pitch (wavelength λ) P: 250 nm

Structure height (amplitude A) H: 150 nm

Aspect ratio (H/P): 0.6

(Sample 4-3)

Similarly to sample 4-1 except change of the following conditions, the optical simulation was performed, and the reflectance spectra were obtained. Then, from the reflectance spectra, the reflected hues a* and b* and the reflection Y values were obtained. The graph of the results is shown in FIG. 26 and Table 4.

(Structure)

Array pitch (wavelength λ) P: 250 nm

Structure height (amplitude A) H: 100 nm

Aspect ratio (H/P): 0.4

(Sample 4-4)

Similarly to sample 4-1 except change of the following conditions, the optical simulation was performed, and the reflectance spectra were obtained. Then, from the reflectance spectra, the reflected hues a* and b* and the reflection Y values were obtained. The graph of the results is shown in FIG. 26 and Table 4.

(Structure)

Array pitch (wavelength λ) P: 400 nm

Structure height (amplitude A) H: 60 nm

Aspect ratio (H/P): 0.15

TABLE 4

| | SAMPLE | SAMPLE | SAMPLE | SAMPLE |
|---|---|---|---|---|
| | 4-1 | 4-2 | 4-3 | 4-4 |
| ASPECT | 0.8 | 0.6 | 0.4 | 0.15 |
| a*(REFLECTION) | −4.68 | −0.85 | 5.17 | −0.13 |
| b*(REFLECTION) | 1.61 | −8.5 | 1.82 | 11.13 |
| Y | 1.18 | 0.57 | 0.62 | 2.35 |

From FIG. 26, the following respects can be seen.

When the aspect of the structures is in the range of 0.2 or more and 1.0 or less, it is possible to obtain an excellent optical adjustment function.

### <5. Electric Reliability>

Regarding samples 5-1 to 5-5, by actually producing the transparent conductive sheet, a study was made on the relationship between the average angle of the inclined surface of the structure and the electric reliability.

(Sample 5-1)

Similarly to sample 2-1 except that the following plural structures were arranged on one principal surface of the PET sheet, the optical sheet was produced.

Array of structures: hexagonal close-packed

Shape of structure: circular frustum shape

Average array pitch Pm of structures: 220 nm

Average structure height Hm: 240 nm

Aspect ratio (Hm/Pm) of structures: 1.091

Average angle of inclined surface of structure θm: 65 degrees

Next, by forming the ITO layer on the PET sheet surface on which the plurality of structures were formed through a sputtering method, the transparent conductive sheet was produced.

Hereinbelow, film formation conditions of the ITO layer will be described.

Gas type: Mixed gas between Ar gas and O₂ gas

Mixing ratio (volume ratio) of mixed gas: Ar:O₂=200:13

Film thickness of ITO layer: 36 nm to 40 nm

Here, the film thickness of the ITO layer is the film thickness at the apex of the structure.

(Sample 5-2)

Similarly to sample 5-1 except that the following plural structures were arranged on one principal surface of the PET sheet, the optical sheet was produced.

Array of structures: hexagonal close-packed

Shape of structure: circular frustum shape

Average array pitch Pm of structures: 250 nm

Average structure height Hm: 180 nm

Aspect ratio (Hm/Pm) of structures: 0.72

Average angle of inclined surface of structure θm: 55 degrees

(Sample 5-3)

Similarly to sample 5-1 except that the following plural structures were arranged on one principal surface of the PET sheet, the optical sheet was produced.

Array of structures: hexagonal close-packed

Shape of structure: circular frustum shape

Average array pitch Pm of structures: 270 nm

Average structure height Hm: 150 nm

Aspect ratio (Hm/Pm) of structures: 0.55

Average angle of inclined surface of structure θm: 70 degrees

(Sample 5-4)

Similarly to sample 5-1 except that the following plural structures were arranged on one principal surface of the PET sheet, the optical sheet was produced.

Array of structures: hexagonal close-packed

Shape of structure: circular frustum shape

Average array pitch Pm of structures: 250 nm

Average structure height Hm: 135 nm

Aspect ratio (Hm/Pm) of structures: 0.54

Average angle of inclined surface of structure θm: 50 degrees

(Sample 5-5)

Similarly to sample 5-1 except that formation of the structures was omitted and the ITO layer with a thickness of 20 nm was formed on one planar principal surface of the PET sheet, the transparent conductive sheet was produced.

(Sample 5-6)

Similarly to sample 5-1 except that formation of the structures was omitted and an NbO layer with a thickness of 20 nm, a SiO₂ layer with a thickness of 90 nm, and the ITO layer with a thickness of 20 nm were sequentially formed on one planar principal surface of the PET sheet, the transparent conductive sheet was produced.

(Heat Shock Test)

First, the transparent conductive sheets, which were produced as described above, were aged at 150 degrees for 30 minutes under air atmosphere. Next, an environment test, in which the sheets were held under low-temperature environment of −30 degrees for 30 minutes and then were held under high-temperature environment of 70 degrees for 30 minutes, was applied to the transparent conductive sheets by 50 cycles. Subsequently, the surface resistances of the transparent conductive sheets were measured by the four-point probe method (JIS K 7194). The results are shown in Table 5.

(High Temperature Test)

First, the transparent conductive sheets, which were produced as described above, were aged at 150 degrees for 30 minutes under air atmosphere. Next, the transparent conductive sheets were held under low-temperature environment of 80 degrees for 240 hours, and then the surface resistances of the transparent conductive sheets were measured by the four-point probe method (JIS K 7194). The results are shown in Table 5.

Table 5 shows the results of the heat shock test and the high temperature test (hereinafter referred to as a reliability test) of samples 5-1 to 5-6.

TABLE 5

| | | STRUCTURE | | | | | |
|---|---|---|---|---|---|---|---|
| | | | | PITCH Pm | HEIGHT Hm | Aspect | AVERAGE ANGLE |
| | CONFIGURATION | ARRAY | SHAPE | (nm) | (nm) | Hm/Pm | θm (DEG) |
| SAMPLE | MOTH-EYE | HEXAGONAL | BELL | 220 | 240 | 109 | 65 |
| 5-1 | STRUCTURE | | FORM | | | | |
| SAMPLE | MOTH-EYE | HEXAGONAL | BELL | 250 | 180 | 072 | 55 |
| 5-2 | STRUCTURE | | FORM | | | | |
| SAMPLE | MOTH-EYE | HEXAGONAL | ELLIPTICAL | 270 | 150 | 055 | 70 |
| 5-3 | STRUCTURE | | FRUSTUM | | | | |
| SAMPLE | MOTH-EYE | HEXAGONAL | BELL | 250 | 135 | 054 | 50 |
| 5-4 | STRUCTURE | | FORM | | | | |
| SAMPLE | ITO SINGLE | — | — | — | — | — | — |
| 5-5 | LAYER | | | | | | |
| SAMPLE | 3-LAYER | — | — | — | — | — | — |
| 5-6 | OPTICAL | | | | | | |
| | MULTILAYER ITO | | | | | | |

| | | HEAT SHOCK TEST | | | HIGH TEMPERATURE TEST | | |
|---|---|---|---|---|---|---|---|
| | | BEFORE | AFTER | SURFACE | BEFORE | AFTER | SURFACE |
| | | SURFACE | SURFACE | RESISTANCE | SURFACE | SURFACE | RESISTANCE |
| | | RESISTANCE | RESISTANCE | CHANGE | RESISTANCE | RESISTANCE | CHANGE |
| | CONFIGURATION | TEST (Ω/□) | TEST (Ω/□) | RATE | TEST (Ω/□) | TEST (Ω/□) | RATE |
| SAMPLE | MOTH-EYE | 688 | 1200 | 1.74 | 600 | 1300 | 2.17 |
| 5-1 | STRUCTURE | | | | | | |
| SAMPLE | MOTH-EYE | 595 | 601 | 1.01 | 503 | 513 | 1.02 |
| 5-2 | STRUCTURE | | | | | | |
| SAMPLE | MOTH-EYE | 503 | 622 | 1.24 | 380 | 434 | 1.14 |
| 5-3 | STRUCTURE | | | | | | |
| SAMPLE | MOTH-EYE | 391 | 388 | 0.99 | 334 | 339 | 1.01 |
| 5-4 | STRUCTURE | | | | | | |
| SAMPLE | ITO SINGLE | 468 | 535 | 1.14 | 491 | 542 | 1.10 |
| 5-5 | LAYER | | | | | | |
| SAMPLE | 3-LAYER | 321 | 379 | 1.18 | 340 | 378 | 1.11 |
| 5-6 | OPTICAL | | | | | | |
| | MULTILAYER ITO | | | | | | |

SURFACE RESISTANCE CHANGE RATE: SURFACE RESISTANCE AFTER TEST/SURFACE RESISTANCE BEFORE TEST

From Table 5, the following respects can be seen.

Regarding samples 5-5 and 5-6 having monolayer ITO and multilayer ITO configurations, the surface resistances thereof through the reliability test increases up to 10% or more.

In sample 5-1 in which the structures with a high aspect of 1.09 was formed on the surface, the inclination angle is 65 degrees and is large, and thus the surface resistance through the reliability test significantly increases.

In sample 5-3 in which the structures with a low aspect of 0.55 is formed, the structure has an elliptical frustum shape. Hence, the inclination angle of the inclined surface is 70 degrees and is large, and thus the surface resistance through the reliability test increases.

In samples 5-2 and 5-4 in which the aspect is 1.0 or less and is low and the inclination angle of the inclined surface is 60 degrees or less and is gentle, the surface resistance through the reliability test is extremely small.

When the ITO layer has a film thickness of several tens of nm, it is considered that a part of the lines thereof is disconnected by stress caused by change of the base material based pm the expansion or contraction percentage thereof. However, it is considered that, by applying the structures onto the surface of the base material, the stress relaxes and the reliability dramatically improves.

Accordingly, in terms of the electric reliability, it is preferable that the structure should have a conic shape of which the apex is a curved surface having a convex shape. Further, in terms of the electric reliability, it is preferable that the average inclination angle of the structure should be 60 degrees or less.

### <6. Reflectance Difference ΔR>

(Sample 6-1)

First, similarly to sample 1-1 except that the following plural structures were arranged on one principal surface of the PET sheet, the optical sheet was produced.

Array of structures: hexagonal lattice

Shape of structure: bell form

Average array pitch Pm of structures: 250 nm

Average structure height Hm of structures: 90 nm

Aspect ratio (Hm/Pm) of structures: 0.36

Average angle θm of inclined portions of structure: 36 deg

Next, by forming the ITO layer on the PET sheet surface on which the plurality of structures were formed through a sputtering method, the transparent conductive sheet was produced.

Hereinbelow, film formation conditions of the ITO layer will be described.

Gas type: Mixed gas between Ar gas and O₂ gas

Mixing ratio (volume ratio) of mixed gas: Ar:O₂=200:13

Film thickness of ITO layer: 30 nm

Here, the film thickness of the ITO layer is the film thickness at the apex of the structure.

Next, the transparent conductive sheet was attached onto the glass substrate of which the refractive index is 1.5 through an adhesive sheet such that the surface thereof on the ITO layer side was close to the surface of the glass substrate.

In the above-mentioned manner, a desirable transparent conductive sheet was produced.

(Sample 6-2)

First, similarly to sample 6-1 except that the formation of the ITO layer was omitted, the optical sheet was produced.

Next, the optical sheet was attached onto the glass substrate of which the refractive index is 1.5 through an adhesive sheet such that the surface thereof, on which the plurality of structures were formed, was close to the surface of the glass substrate.

In the above-mentioned manner, a desirable optical sheet was produced.

(Sample 6-3)

Similarly to sample 6-1 except that formation of the structures was omitted and the ITO layer with a thickness of 30 nm was formed on one planar principal surface of the PET sheet, the transparent conductive sheet was produced.

(Sample 6-4)

Similarly to sample 6-3 except that the formation of the ITO layer was omitted, the optical sheet was produced.

(Reflectance Spectra)

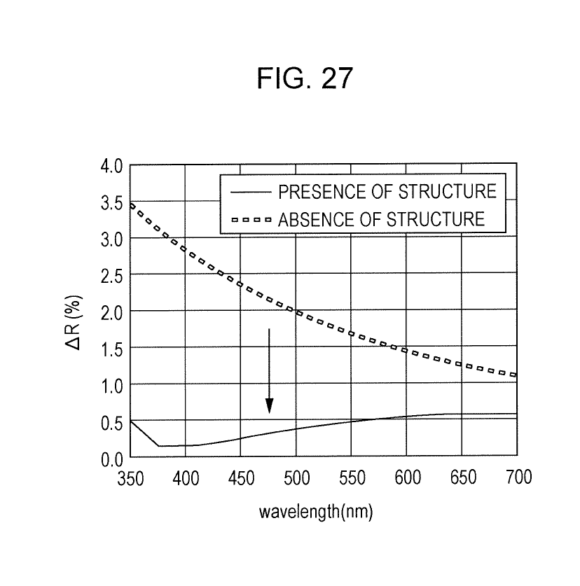

First, black tapes were attached onto the surfaces on sides opposite to sides to which the glass substrates of the transparent conductive sheets and the optical sheets produced as described above were attached, whereby the measurement samples were produced. Next, the reflectance spectra of the measurement samples in a wavelength band (350 nm to 700 nm) near the visible wavelength band were measured by a spectrophotometer (JASCO Corporation, product name: V-550). Subsequently, the differences ΔR of the reflectances were calculated by the following expressions. The calculation results of the differences ΔR of the reflectances are shown in FIG. 27. The calculation results of the differences ΔR of the luminous reflectances are shown in Table 6. Here, the luminous reflectance is defined as a reflectance at a wavelength of 550 nm.

ΔR=((reflectance of sample 6-2)−(reflectance of sample 6-1))

ΔR=((reflectance of sample 6-4)−(reflectance of sample 6-3))

(Reflected Hue)

From the reflectance spectra which were measured as described above, the reflected hues a* and b* were calculated. The results are shown in Table 6.

Table 6 shows the calculation results of the reflected hues and the differences ΔR of the luminous reflectances of samples 6-1 to 6-4.

TABLE 6

| | PRESENCE | PRESENCE | | a* | b* |
|---|---|---|---|---|---|
| | OF | OF ITO | | (REFLEC- | (REFLEC- |
| | STRUCTURE | LAYER | ΔR | TION) | TION) |
| SAMPLE | YES | YES | 0.5 | 0.1 | 3 |
| 6-1 | | | | | |
| SAMPLE | YES | NO | | 0.44 | −0.55 |
| 6-2 | | | | | |
| SAMPLE | NO | YES | 1.7 | 0.5 | −10.5 |
| 6-3 | | | | | |
| SAMPLE | NO | NO | | 0.44 | −0.55 |
| 6-4 | | | | | |

From FIG. 27 and Table 6, the following respects can be seen.

By forming the transparent conductive layer on the structures of which the inclination angles were controlled, it is possible to suppress the difference ΔR of the luminous reflectances. Further, it is possible to decrease the absolute values of a* and b* values.

### <7. Shape of Structure>

Regarding samples 7-1 to 7-3, through the optical simulation based on RCWA (Rigorous Coupled Wave Analysis), a study was made on the relationship between the shape of the structure and the reflectance.

(Sample 7-1)

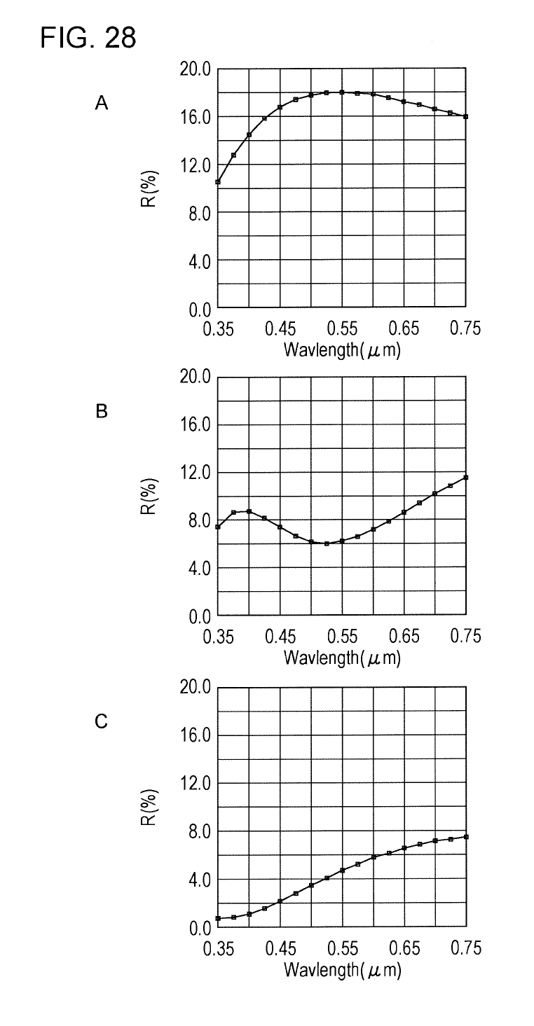

Through the optical simulation, the reflectance spectra of the transparent conductive elements were obtained, and from the reflectance spectra, the reflected hues a* and b* were obtained. The results are shown in FIG. 28A and Table 7.

Hereinbelow, the conditions of the optical simulation will be described.

(Configuration of Transparent Conductive Element)

The transparent conductive element is formed of the following laminated structures.

(Incidence side) base substance/structures/transparent conductive layer/optical layer (exit side)

(Base Substance)

Refractive index n: 1.52

(Transparent Conductive Layer)

Refractive index n of transparent conductive layer: 2.0

Thickness t of transparent conductive layer: 70 nm

(Resin Layer on Exit Surface Side)

Refractive index n: 1.52

(Incident Light)

Polarization: no polarization

Incident angle: 5 degrees (with respect to normal line of transparent conductive element)

(Sample 7-2)

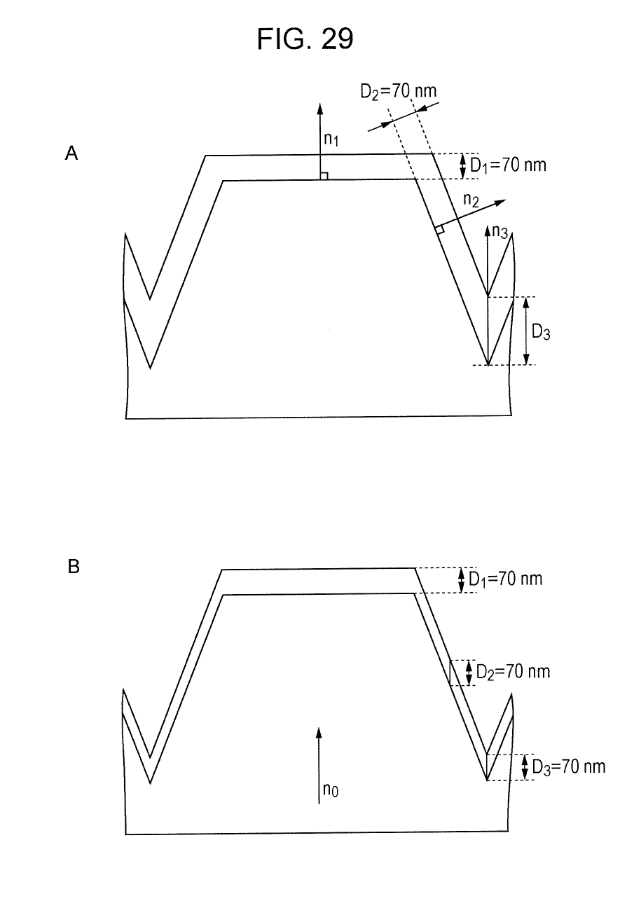

FIG. 29A is a sectional view illustrating thicknesses D1, D2, and D3 of the transparent conductive layer of sample 7-2. In FIG. 29A, n₁, n₂ and n₃ respectively represent directions of the perpendicular lines to the apex of the structure, the inclined surface of the structure, and the space between structures. The film thickness D1, the film thickness D2, and the film thickness D3 respectively represent: a thickness of the transparent conductive layer in the n₁ direction of the perpendicular line to the apex of the structure; a thickness of the transparent conductive layer in the n₂ direction of the perpendicular line to the inclined surface of the structure; and a thickness of the transparent conductive layer in the n₃ direction of the perpendicular line to the space between structures.

Through the optical simulation, the reflectance spectra of the transparent conductive elements were obtained, and from the reflectance spectra, the reflected hues a* and b* were obtained. The results are shown in FIG. 28B and Table 7.

Hereinbelow, the conditions of the optical simulation will be described.

(Configuration of Transparent Conductive Element)

The transparent conductive element is formed of the following laminated structures.

(Incidence side) base substance/structures/transparent conductive layer/optical layer (exit side)

(Base Substance)

Refractive index n: 1.52

(Structure)

Array of structures: square lattice

Shape of structure: quadrangular pyramid (length of side of bottom face: 100 nm, and length of side of upper surface: 40 nm)

Bottom face of structure: quadrangle

Refractive index n of structure: 1.52

Array pitch P: 120 nm

Height of structure H: 100 nm

Aspect ratio (H/P): 0.83

(Transparent Conductive Layer)

As shown in FIG. 29A, the transparent conductive layer was set such that the thickness D1 of the transparent conductive layer in the direction n₁ of the perpendicular line to the apex of the structure and the thickness D2 of the transparent conductive layer in the direction n₂ of the perpendicular line to the inclined surface of the structure were equal to 70 nm.

Refractive index n of transparent conductive layer: 2.0

Thickness D1 of transparent conductive layer at apex of structure: 70 nm

Thickness D2 of transparent conductive layer on inclined surface of the structure: 70 nm

Film thickness ratio D3/D1: 1 or more

(Resin Layer on Exit Surface Side)

Refractive index n: 1.52

(Incident Light)

Polarization: no polarization

Incident angle: 5 degrees (with respect to normal line of transparent conductive element)

(Sample 7-3)

FIG. 29B is a sectional view illustrating thicknesses D1, D2, and D3 of the transparent conductive layer of sample 7-3. In FIG. 29B, n₀ represents the direction of the perpendicular lines to the transparent conductive element surface (or the base substance surface). The film thickness D1, the film thickness D2, and the film thickness D3 respectively represent: a thickness of the transparent conductive layer in the direction n₀ of the perpendicular line at the apex of the structure; a thickness of the transparent conductive layer in the direction n₀ of the perpendicular line on the inclined surface of the structure; and a thickness of the transparent conductive layer in the direction n₀ of the perpendicular line at the space between structures.

Similarly to test example 1 except change of the following conditions, the optical simulation was performed, and the reflectance spectra were obtained. Then, from the reflectance spectra, the reflected hues a* and b* were obtained. The results are shown in FIG. 28C and Table 7.

(Transparent Conductive Layer)

As shown in FIG. 29B, the transparent conductive layer was set such that the thickness D1 of the transparent conductive layer in the direction n₀ of the perpendicular line at the apex of the structure, the thickness D2 of the transparent conductive layer in the direction n₀ of the perpendicular line on the inclined surface of the structure, and the thickness D3 of the transparent conductive layer in the direction n₀ of the perpendicular line at the space between structures, all the thicknesses were equal to 70 nm.

Refractive index n of transparent conductive layer: 2.0

Thickness D1 of transparent conductive layer at apex of structure: 70 nm

Thickness D3 of transparent conductive layer between structures: 70 nm

Film thickness ratio D3/D1: 1

Table 7 shows the calculation results of the luminous reflectances and the transmitted hues of sample 7-1 to 7-3.

TABLE 7

| | FILM | | LUMINOUS | a* | b* |
|---|---|---|---|---|---|
| | FORMATION SURFACE | THICKNESS | REFLECTANCE | (REFLECTION) | (REFLECTION) |
| SAMPLE | PLANAR SURFACE | 70 nm | 18.0% | −1.6 | 2.3 |
| 7-1 | | | | | |
| SAMPLE | STRUCTURE | APEX THICKNESS | 6.6% | 6.0 | −2.8 |
| 7-2 | FORMATION SURFACE | D1: 70 nm | | | |
| | | INCLINED SURFACE | | | |
| | | THICKNESS | | | |
| | | D2: 70 nm | | | |
| SAMPLE | STRUCTURE | APEX THICKNESS | 4.8% | 1.8 | 16.0 |
| 7-3 | FORMATION SURFACE | D1: 70 nm | | | |

From FIGS. 28A to 28C and Table 7, the following respects can be seen.

In sample 7-1 having a configuration in which the transparent conductive layer is formed on a planar surface, the absolute values of a* and b* are small, but the luminous reflectance increases.

In sample 7-2 in which the transparent conductive layer is formed on the structures so as to have a regular thickness, it is possible to reduce the luminous reflectance to some extent, but the absolute values of a* and b* increase.

In sample 7-3 in which the transparent conductive layer is formed on the structures so as to have a regular thickness in the direction of the perpendicular line to the surface where the structures are formed, it is possible to reduce the luminous reflectance, but the absolute values of a* and b* increase.

### <8. Electrode Pattern Distortion>

Regarding samples 8-1 and 8-2, by actually producing the transparent conductive sheet, a study was made on the relationship of presence or absence of the structures and electrode pattern distortion.

(Sample 8-1)

Similarly to sample 1-1 except that the following plural structures were arranged on one principal surface of the PET sheet, the optical sheet was produced.

Array of structures: hexagonal close-packed

Shape of structure: circular frustum shape

Array pitch P: 250 nm

Height of structure H: 150 nm

Aspect ratio: 0.6

Average angle of inclined portion: 50 deg

Next, the ITO layer was formed on the PET sheet surface on which the plurality of structures were formed through the sputtering method.

Hereinbelow, film formation conditions of the ITO layer will be described.

Gas type: Mixed gas between Ar gas and O₂ gas

Mixing ratio (volume ratio) of mixed gas: Ar:O₂=200:10

Film thickness of ITO layer: 30 nm

Here, the film thickness of the ITO layer is the film thickness at the apex of the structure.

Subsequently, by patterning the ITO layer so as to form the plurality of electrodes in which diamond shapes are connected, the transparent conductive sheet was produced. Next, the two transparent conductive sheets, which were produced as described above, were attached by the ultraviolet curable resin such that the surface, on which the plurality of electrodes were formed, was the upper side thereof and the electrodes with the diamond shapes did not overlap each other. Then, the transparent conductive sheet, which is positioned on the upper side, was attached onto the glass substrate of which the refractive index is 1.5 through the adhesive sheet such that the surface thereof on the ITO layer side was close to the surface of the glass substrate.

In the above-mentioned manner, it was possible to obtain a desirable input element.

(Sample 8-2)

Similarly to sample 8-1 except that formation of the structures was omitted and the ITO layer was formed on one planar principal surface of the PET sheet, the input element was produced.

(Pattern Distortion Evaluation)

The fluorescent light was photographed through the surface of the input element which was produced as described above, and it was observed whether or not distortion due to the electrode pattern occurred on the input element surface. As a result, distortion was not observed in sample 8-1, while distortion was observed in sample 8-2.

### <9. Etching Resistance>

(Sample 9-1)

(Transfer Process)

Similarly to sample 2-1 except that the following plural structures were arranged on one principal surface of the PET sheet, the optical sheet was produced.

Array of structures: hexagonal close-packed

Shape of structure: bell form

Array pitch P: 250 nm

Height of structure H: 180 nm

Aspect ratio: 0.55

Average angle of inclined surfaces: 55 degrees

(Film Formation Process)

Next, the ITO layer was formed on the PET sheet surface on which the plurality of structures were formed through the sputtering method.

Hereinbelow, film formation conditions of the ITO layer will be described.

Gas type: Mixed gas between Ar gas and O₂ gas

Mixing ratio (volume ratio) of mixed gas: Ar:O₂=200:10

Film thickness of ITO layer: 30 nm

Here, the film thickness of the ITO layer is the film thickness at the apex of the structure.

(Annealing Process)

Subsequently, annealing was performed on the PET sheet, on which the ITO layer was formed, at 150° C. for 120 minutes in air. Thereby, poly crystallization of the ITO layer was accelerated. Next, in order to check this acceleration state, the ITO layer was measured by using X-ray diffraction (XRD), and then the peak of In₂O₃ was observed.

In the above-mentioned manner, a desirable transparent conductive sheet was produced.

(Sample 9-2)

(Transfer Process, Film Formation Process, Annealing Process)

First, similarly to sample 9-1, the transfer process, the film formation process, and the annealing process were sequentially performed, and the PET film having the ITO layer, on which the annealing treatment was performed, was produced.

(Etching Process)

Next, the PET film, to which the annealing treatment was applied, was immersed in a diluted solution of HCl 10% for 20 seconds, whereby the ITO layer was etched.

(Cleaning Process)

Subsequently, pure water cleaning was performed on the PET sheet to which the etching treatment is applied.

In the above-mentioned manner, a desirable transparent conductive sheet was produced.

(Sample 9-3)

Similarly to sample 9-2 except that the immersion time was changed into 40 seconds, the transparent conductive sheet was produced.

(Sample 9-4)

Similarly to sample 9-2 except that the immersion time was changed into 60 seconds, the transparent conductive sheet was produced.

(Sample 9-5)

Similarly to sample 9-2 except that the immersion time was changed into 100 seconds, the transparent conductive sheet was produced.

(Sample 10-1)

Similarly to sample 9-1 except that the following plural structures were arranged on one principal surface of the PET sheet, the transparent conductive sheet was produced.

Array of structures: hexagonal close-packed

Shape of structure: bell form

Array pitch P: 200 nm

Height of structure H: 180 nm

Aspect ratio: 0.62

Average angle of inclined surfaces: 61 degrees

(Sample 10-2)

(Transfer Process, Film Formation Process, Annealing Process)

First, similarly to sample 10-1, the transfer process, the film formation process, and the annealing process were sequentially performed, and the PET film having the ITO layer, on which the annealing treatment was performed, was produced.

(Etching Process)

Next, the PET film, to which the annealing treatment was applied, was immersed in a diluted solution of HCl 10% for 20 seconds, whereby the ITO layer was etched.

(Cleaning Process)

Subsequently, pure water cleaning was performed on the PET sheet to which the etching treatment is applied.

In the above-mentioned manner, a desirable transparent conductive sheet was produced.

(Sample 10-3)

Similarly to sample 10-2 except that the immersion time was changed into 40 seconds, the transparent conductive sheet was produced.

(Sample 10-4)

Similarly to sample 10-2 except that the immersion time was changed into 60 seconds, the transparent conductive sheet was produced.

(Sample 10-5)

Similarly to sample 10-2 except that the immersion time was changed into 100 seconds, the transparent conductive sheet was produced.

(Surface Resistance)

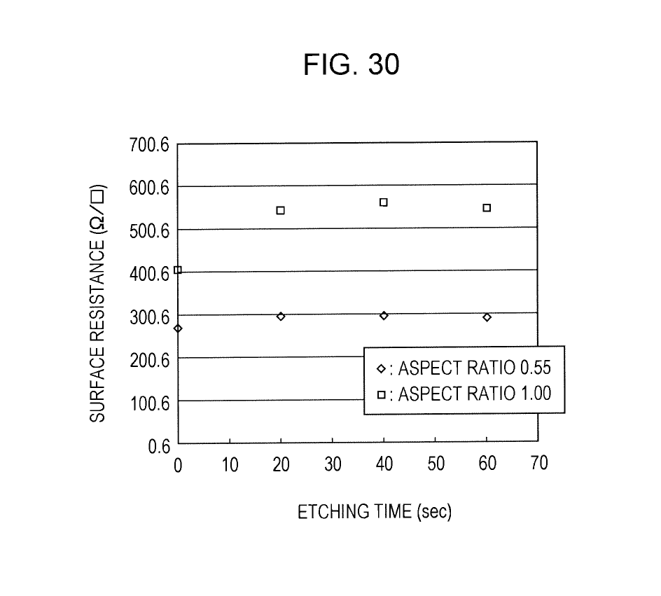

The surface resistance values of the transparent conductive sheet surfaces of samples 9-1 to 10-5, which could be obtained as described above, were measured by the four-point probe method. The results are shown in Table 8 and FIG. 30.

(Inverse of Initial Change Rate)

The inverses (changes in virtual thicknesses) of the initial change rates of the transparent conductive sheet surfaces of samples 9-1 to 10-5, which could be obtained as described above, were obtained from the following expression. The results are shown in Table 9.

(Inverse of change rate with respect to initial surface resistance)=(surface resistance of sample before etching)/(surface resistance of sample after etching)

Table 8 shows the evaluation results of the surface resistances of the transparent conductive sheets according to samples 9-1 to 10-5.

TABLE 8

| | STRUCTURE | | | | | | | | |
|---|---|---|---|---|---|---|---|---|---|
| | | | INCLINED | | | | | | |
| | | | SURFACE | | | | | | |
| | | | AVERAGE | | | | | | |
| | PITCH | HEIGHT | ANGLE | | IMMERSION TIME (sec) | | | | |
| | (nm) | (nm) | (DEG) | Aspect | 0 | 20 | 40 | 60 | 100 |
| SAMPLES | 250 | 180 | 55 | 0.55 | 270 | 298 | 298 | 295 | 300 |
| 9-1~9-5 | | | | | | | | | |
| SAMPLES | 200 | 180 | 61 | 0.62 | 405 | 543 | 560 | 550 | 588 |
| 10-1~10-5 | | | | | | | | | |

UNIT: Ω/□

Table 9 shows the evaluation results of the inverses of the initial change rates of the transparent conductive sheets according to samples 9-1 to 10-5.

TABLE 9

| | STRUCTURE | | | | | | | | |
|---|---|---|---|---|---|---|---|---|---|
| | | | INCLINED | | | | | | |
| | | | SURFACE | | | | | | |
| | | | AVERAGE | | | | | | |
| | PITCH | HEIGHT | ANGLE | | IMMERSION TIME (sec) | | | | |
| | (nm) | (nm) | (DEG) | Aspect | 0 | 20 | 40 | 60 | 100 |
| SAMPLES | 250 | 180 | 55 | 0.55 | 1.000 | 0.906 | 0.906 | 0.915 | 0.900 |
| 9-1~9-5 | | | | | | | | | |
| SAMPLES | 200 | 180 | 61 | 0.62 | 1.000 | 0.746 | 0.723 | 0.736 | 0.689 |
| 10-1~10-5 | | | | | | | | | |

From Tables 8 and 9 and FIG. 30, the following respects can be seen.

When the average angle of the inclined surfaces exceeds 60 degrees, the etching resistance of the ITO layer decreases, the surface resistance tends to increase in accordance with the passage of the etching time.

The embodiments of the present invention were hitherto described in detail. However, the present invention is not limited to the above-mentioned embodiments, and may be modified into various forms based on the technical scope of the present invention.

For example, in the above-mentioned embodiments, the configurations, the methods, the processes, the shapes, the materials, the numerical values, and the like are examples in all respects, and if necessary, the other configurations, methods, processes, shapes, materials, numerical values, and the like may be used.

Further, the configurations, the methods, the processes, the shapes, the materials, the numerical values, and the like of the above-mentioned embodiments may be combined without departing from the technical scope of the present invention.

### EXPLANATION OF REFERENCE NUMERALS

1 TRANSPARENT CONDUCTIVE ELEMENT
1₁ FIRST TRANSPARENT CONDUCTIVE ELEMENT
1₂ SECOND TRANSPARENT CONDUCTIVE ELEMENT
2, 2₁, 2₂ OPTICAL LAYER
3, 3₁, 3₂ BASE SUBSTANCE
4, 12 STRUCTURES
5, 5₁, 5₂ BASAL LAYER
6, 6₁, 6₂ TRANSPARENT CONDUCTIVE LAYER
7 OPTICAL LAYER
8 PASTE LAYER
11 ROLL MASTER MOLD
101 INFORMATION INPUT DEVICE
Sw WAVE SURFACE

1-12. (canceled)

13. A transparent conductive element comprising:
an optical layer on which a wave surface with an average wavelength equal to or less than a wavelength of visible light is provided; and
a transparent conductive layer that is formed on the wave surface so as to follow the corresponding wave surface,
wherein assuming that the average wavelength of the wave surface is λm and an average width of oscillation of the wave surface is Am, a ratio of (Am/λm) is 0.2 or more and 1.0 or less,
wherein the average wavelength λm of the wave surface is 140 nm or more and 300 nm or less,
wherein a film thickness of the transparent conductive layer at a position, at which a height of the wave surface is maximized, is 100 nm or less,
wherein an area of a planar portion of the wave surface is 50% or less, and
wherein a reflected hue on the wave surface side in an L*a*b* color system is |a*|≦10 and |b*|≦10.

14. The transparent conductive element according to claim 13, wherein the transparent conductive layer has a prescribed pattern.

15. The transparent conductive element according to claim 13, wherein a reflectance difference ΔR between a part, in which the transparent conductive layer is formed, and a part, in which the transparent conductive layer is not formed, on the wave surface of the optical layer is 5% or less.

16. The transparent conductive element according to claim 13, wherein a transmitted hue at a surface opposite to the wave surface in the L*a*b* color system is |a*|≦10 and |*b|≦10.

17. The transparent conductive element according to claim 1, further comprising an optical layer provided on the transparent conductive layer.

18. The transparent conductive element according to claim 17, wherein the transmitted hue at the surface opposite to the wave surface in the L*a*b* color system is |a*|≦5 and |b*|≦5.

19. The transparent conductive element according to claim 13, wherein the average width Am of the oscillation of the wave surface is 28 nm or more and 300 nm or less.

20. The transparent conductive element according to claim 13,
wherein the optical layer includes
a base substance which has surfaces, and
a plurality of structures which are arranged on the surface of the base substance at a fine pitch equal to or less than the wavelength of visible light, and
wherein the wave surface is formed by the array of the plurality of structures.

21. The transparent conductive element according to claim 20, wherein assuming that a film thickness of the transparent conductive layer at an apex of the structures is D1 and a film thickness of the transparent conductive layer between the structures is D3, a ratio of (D3/D1) is 0.8 or less.

22. An input device comprising the transparent conductive element according to claim 13.

23. A display apparatus comprising the transparent conductive element according to claim 13.

24. A master mold for manufacturing the transparent conductive element according to claim 13.
